(19) United States
(12) Patent Application Publication
(10) Pub. No.: US 2001/0042036 A1
(43) Pub. Date: Nov. 15, 2001

(54) Method and system for investing in customizable investment products

(76) Inventor: Steven J. Sanders, Thornwood, NY (US)

Correspondence Address: George T. Marcou, Esq., Kilpatrick Stockton LLP, 700 13th Street, N W, Suite 800, Washington, DC, 20005, US

(21) Appl. No.: 09/769,794

(22) Filed: Jan. 25, 2001

Related U.S. Application Data
(60) Provisional application No. 60/177,981, filed on Jan. 25, 2000.

(51) Int. Cl. G06F 17/60

(52) U.S. Cl. 705/36

(57) ABSTRACT

A method and system for investing in customizable investment products utilizes a retail distributor platform with a retail customer interface coupled to an exchange platform and a product market maker platform also coupled to the exchange platform. An investor is allowed to access the exchange platform and enter a selection of at least one customizable investment product from a list of such products displayed for the investor. Upon receipt of the investor's selection, the investor is prompted to customize the product by entering a selection of terms for the product from a menu of terms displayed for the investor. A pricing engine of the exchange platform calculates the best price quote for the customized investment product on the basis of input from a plurality of competing product market makers and sends the price quote to the investor. Upon receipt of the investor's acceptance of the price quote, the exchange platform executes a trade for the investor based on the acceptance.

### PRIORITY APPLICATION

This application claims the benefit of U.S. Provisional Application No. 60/177,981 filed Jan. 25, 2000, U.S. Provisional Application No. 60/178,454 filed Jan. 27, 2000, U.S. Provisional Application No. 60/190,971 filed Mar. 22, 2000, and U.S. Provisional Application No. 60/200,951 filed May 1, 2000, incorporated herein by this reference.

### FIELD OF THE INVENTION

The present invention relates generally to the field of investing, and more particularly to a method and system for investing in customizable investment products, such as consumer-friendly customizable retail investment contracts.

### BACKGROUND OF THE INVENTION

Major capital markets participants have been offering individually tailored structured products to institutions and high net worth individuals for a number of years. However, these products are complex and not easily understood. Currently, the vast majority of Retail Investors are unable to tailor financial products to meet individual needs. Retail brokers suffer from the limitation that they offer prices only on a finite number of securities. There is a significant need for products that offer customization to the retail market, which would remove that limitation. Further, the traditional investment product processing flow is fragmented among many participants and is highly inefficient, and many reconciliations are needed to keep all the participants synchronized.

### SUMMARY OF THE INVENTION

It is a feature and advantage of the present invention to provide a method and system for investing in customizable investment products that affords greater flexibility in product design.

It is another feature and advantage of the present invention to provide a method and system for investing in customizable investment products that makes use of consumer-oriented communication.

It is an additional feature and advantage of the present invention to provide a method and system for investing in customizable investment products that offers consumers products targeted to meet specific consumer wants and needs.

It is a further feature and advantage of the present invention to provide a method and system for investing in customizable investment products that includes integrated marketing programs.

It is another feature and advantage of the present invention to provide a method and system for investing in customizable investment products that affords potential access to global markets.

It is a still further feature and advantage of the present invention to provide a method and system for investing in customizable investment products that simplifies pricing.

It is an additional feature and advantage of the present invention to provide a method and system for investing in customizable investment products that makes use of a technology platform with “straight through processing” capabilities.

It is a further feature and advantage of the present invention to provide a method and system for investing in customizable investment products including a technology platform that eliminates the need for many operational participants, and places all processes in one place with one database.

It is still another feature and advantage of the present invention to provide a method and system for investing in customizable investment products that are both easy to comprehend and beneficial to the retail market.

It is an additional feature and advantage of the present invention to provide a method and system for investing in customizable investment products that utilizes a complete infrastructure needed to profitably offer and distribute these products.

To achieve the stated and other features, advantages and objects, an embodiment of the present invention provides a method and system for investing in customizable investment products that allows the aggregation of small retail contracts into a larger portfolio for the purpose of efficient hedging. The method and system for an embodiment of the present invention also gives Product Market Makers and Retail Distributors the ability to offer customized retail investment contracts, known as CybicBulls and Bears, CybicProtects, CybicFunds, and CybicSecure.

An embodiment of the present invention, for example, enables international derivatives dealers to link with retail brokerage firms in the offering of customizable consumer-friendly investments products to the retail market. An embodiment of the present invention provides customizable consumer-friendly investment products and provides Product Market Makers, such as international derivatives dealers, and Retail Distributors, such as retail brokerage firms, with the complete bridge infrastructure needed to offer, clear, and deliver these products. An embodiment of the present invention also enables Retail Distributors to offer products that match their Retail Investor's individual financial needs directly from Product Market Maker wholesalers.

The customizable consumer-friendly investment products provided by an embodiment of the present invention include, for example, the products referred to as CybicBulls and Bears, CybicProtects, CybicFunds, and CybicSecure. CybicBulls and Bears, for example, are $100 unit spread option contracts. The Retail Investor determines a leverage factor (the “Share Multiple”), and the Product Market Makers, through a facility known as the Cybic Exchange, bid to determine a cap on gains (the “Return Cap”). CybicBulls and CybicBears offer a Retail Investor a greater potential for return than currently available standard call or put options, while limiting losses to the Retail Investor's initial investment. In submitting an inquiry through a Retail Distributor, a Retail Investor chooses an underlying equity or index, a maturity, such as 1, 2, 3, 6, or 12 months, a number of investment units, and a Share Multiple, for example, from five to twenty, reflecting the Retail Investor desired return leverage. The Retail Investor is then quoted a Return Cap.

At maturity for CybicBulls, the Retail Investor receives the initial investment, plus the dollar increase or minus the dollar decrease on the underlying security or index, determined from time of purchase, times the Share Multiple. At maturity for CybicBears, the Retail Investor receives the initial investment, plus the dollar decrease or minus the dollar increase on the underlying security or index, determined from the time of purchase, times the Share Multiple. The Retail Investor can lose no more than the initial investment, and can gain no more than the Return Cap. CybicBears and CybicBulls are redeemable at any time prior to maturity for the current market price as determined by the best bid among at least three product Market Makers. All Product Market Makers' fees, exchange transaction fees, and Retail Distributors' commissions are built into the Return Cap, rather than being charged as an additional fee.

In an embodiment of the present invention, CybicProtects are $100 unit collar option contracts. The Retail Investor determines a floor on losses, and the Product Market Makers, through the facilities of the Cybic Exchange, bid to determine a cap on gains (the “Return Cap”). CybicProtects offer flexible protection of initial investment, unlike currently available equity and mutual fund investments. In submitting an inquiry through a Retail Distributor, a Retail Investor chooses an underlying equity or index, a maturity, for example, of one to five years, a number of $100 investment units, and the percent of the initial investment to be protected (the “Protection Percentage”), which can be no less than a predetermined amount, such as 90 percent. The Retail Investor is then quoted a Return Cap reflecting the maximum percentage profit that the Retail Investor can make on the investment.

At maturity for the CybicProtects, the Retail Investor receives the initial investment, plus or minus the return on the underlying security or index, with losses protected at the Protection Percentage and gains capped at the Return Cap. CybicProtects are redeemable, for example, at any time prior to maturity for the current market price as determined by the best bid among a pre-selected number of Product Market Makers, such as three Product Market Makers. All Product Market Makers' fees, exchange transaction fees and Retail Distributors' commissions are built into the Return Cap, rather than being charged as an additional fee.

CybicFunds are $100 unit investment contracts on an index or basket and operate much like a mutual fund. CybicFunds allow a Retail Investor to invest in an index fund that triggers no tax gain/loss until sale, that offers an exact index payout plus dividends, and that provides real-time pricing. A CybicSecure allows a Retail Investor to wrap a protection collar around an existing equity position at no “out-of-pocket” cost.

An embodiment of the present invention makes use of a technology platform referred to as the Cybic technology platform. An advantage of the Cybic technology platform is its “straight through processing” capabilities and its components design. Currently, the traditional investment product processing flow is fragmented among many participants and is highly inefficient. Many reconciliations are needed to keep all the participants synchronized. The Cybic technology platform for an embodiment of the present invention eliminates the need for many operational participants, and places all processes in one place with one database.

In an embodiment of the present invention, a Retail Investor customizes the terms of the product and sends a request to the Cybic Exchange for a price. On a real-time basis, the Exchange calculates a price for the requested product based on input from at least three Product Market Makers. The Retail Investor is offered the best price and has, for example, thirty seconds from the time the quote leaves the Cybic Exchange's server to purchase the Cybic product at the offered price. If the Retail Investor purchases the Cybic product, the order is immediately filled and the Retail Investor receives a confirmation. The Product Market Maker's risk position is immediately updated. The Cybic technology platform performs two main functions, namely, exchange functions and clearing and record keeping functions. Both of these functions are centralized, with the Product Market Makers and the Retail Distributors linking to a single source of information.

In the method and system for an embodiment of the present invention, an investor (or Retail Investor) at a computing device, such as the investor's personal computer, is allowed to logon to a broker's (or Retail Distributor's) website and seamlessly access the exchange platform (or Cybic technology platform) for the system via a retail customer interface. The investor is prompted to enter a selection of at least one customizable investment product from a list of such products displayed for the investor by the exchange platform via the retail customer interface. The displayed list of customizable investment products includes, for example, one or more of an individual equity related contract with downside protection (or CybicProtects), a leveraged individual equity contract with limited downside (or CybicBulls/Bears), an equity index contract with an index payout plus a contracted premium (or CybicFunds), and a collar protection contract for use with an existing equity position with downside protection (or CybicSecure). In response to the prompt, the investor enters a selection for at least one of the products from the displayed list, and the selection is received by the exchange platform via the retail customer interface.

Upon receipt by the exchange platform of the investor's selection of a customizable investment product, the investor is prompted to customize the product by entering a selection of terms for the product from a menu of terms displayed for the investor by the exchange platform via the retail customer interface. The displayed menu of term selections includes, for example, one or more of a maturity and a protection level for the individual equity related contract, a maturity and a leverage factor for the leveraged individual equity contract, an index and a sum to invest for the equity index contract, and a period of time for protection and a protection level for the collar protection contract. In response to the prompt, the investor enters a selection for one or more of the terms from the displayed menu, and the selection is received by the exchange platform via the retail customer interface.

If the inventor selects the underlying individual equity related contract, the investor can enter one or more terms, such as a number of investment units, a maturity, and a protection level, in response to which, the exchange platform furnishes the investor a quote for a maximum potential investor gain. If the investor selects the leveraged individual equity contract, the investor can enter one or more terms, such as a number of investment units, a maturity, and a leverage factor, in response to which, the exchange platform furnishes the investor a quote for a maximum potential investor gain. If the inventor selects an equity index contract, the investor can enter one or more terms, such as an index and a sum to invest, in response to which, the exchange platform furnishes the investor a quote for a lowest management fee offered by a plurality of product market makers. If the inventor selects a collar protection contract, the investor can enter one or more terms, such as an existing equity position to protect, a number of shares to protect, a protection level, and a period of time for protection, in response to which, the exchange platform furnishes the investor a quote for a maximum potential investor gain.

Once the investor has entered selections for the customizable investment product and terms for the selected product, the investor can enter a request for a best price quote to the exchange platform via the retail customer interface. Upon receipt of the request for quote, the exchange platform checks for an approval for the investor to trade in the customizable investment product for which the quote is requested and rejects the request for quote and notifies the investor of the rejection, if the approval is not found. If the approval is found, a pricing engine of the exchange platform calculates the best price quote for the customizable investment product according to the selected terms on the basis of input from a plurality of competing product market makers. Factored in the calculation are, for example, one or more of a retail distributor fee for the customizable product, a product market maker volatility bid-ask spread for the customizable product, and an exchange transaction fee for the customizable product.

The pricing engine sends the calculated best price quote to the investor via the retail customer interface. For the individual equity related contract, the best price quote includes, for example, a maximum potential investor gain. For the leveraged individual equity contract, the best price quote includes, for example, a maximum potential investor gain. For the equity index contract, the best price quote includes a lowest available management fee. For the collar protection contract, the best price quote includes, for example, a maximum potential gain on the existing position. If the investor wishes to accept the best price quote, the investor enters an acceptance to the exchange platform via the retail customer interface. Upon receipt of the investor's acceptance, the exchange platform executes a trade for the investor based on the acceptance. In another aspect of the present invention, the best price quote is held open by the exchange platform for acceptance by the investor within a pre-determined time-out period. In this aspect, the exchange platform executes the trade for the investor if the investor's acceptance is received within the pre-determined time-out period.

In executing the trade for the investor, the exchange platform queries an account limit and a current trading limit for the investor. Upon confirming acceptable account and current trading limits by the exchange platform, a contract relative to the trade is established between an options clearing entity and a retail distributor, and an identical and offsetting contract is established between the options clearing entity and a product market maker. The options clearing entity guarantees all obligations under the contract relative to the trade. In addition, a record of the executed trade is centrally maintained for the options clearing entity, the product market maker, and the retail distributor. An additional aspect of the present invention includes confirming the trade to the investor by the exchange platform via the retail customer interface.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 is a schematic flow diagram which illustrates an example of key components and the flow of information between the key components for an embodiment of the present invention;

FIG. 2 is a schematic chart which illustrates examples of the general responsibilities of the Product Market Makers, the Retail Distributors and Cybic, Inc. for an embodiment of the present invention;

FIG. 3 is a table which illustrates examples of customizable Cybic products for an embodiment of the present invention;

FIG. 4 is a table which shows an example of comparisons of the benefits of the CybicProtects product for an embodiment of the present invention to equities or mutual fund instruments;

FIG. 5 is a table which shows an example of a comparison of benefits of CybicBulls/Bears for an embodiment of the present invention to standard put and call options;

FIG. 6 is a schematic diagram which shows aspects of the Cybic technology platform for an embodiment of the present invention and examples of functional systems with which the Cybic technology platform interfaces;

FIG. 7 is a flow chart which illustrates an example of the process of investing in a customized Cybic product for an embodiment of the present invention;

FIG. 8 is a table which illustrates an example of a scorecard question and point values for an embodiment of the present invention;

FIG. 9 is a table which illustrates an example of percentage weighting factors for scoreboard questions for an embodiment of the present invention;

FIG. 10 is a table which illustrates an example of scoreboard trading limits for particular products for an embodiment of the present invention; and

FIG. 11 is a flow chart which illustrates an example of the process of interbroker transfer by a Retail Investor between two Retail Distributors for an embodiment of the present invention.

### DETAILED DESCRIPTION

Referring now in detail to an embodiment of the invention, an example of which is illustrated in the accompanying drawings, the present invention provides a method and system for investing in customizable investment products. Today, the vast majority of Retail Investors are unable to tailor financial products to meet individual needs. Major capital markets participants have been offering individually tailored structured products to institutions and high net worth individuals for a number of years. However, these products are complex and not easily understood. An embodiment of the present invention provides customizable investment products that are both easy to comprehend and beneficial to the retail market. In addition, an embodiment of the present invention also provides a complete infrastructure needed to profitably offer and distribute these products.

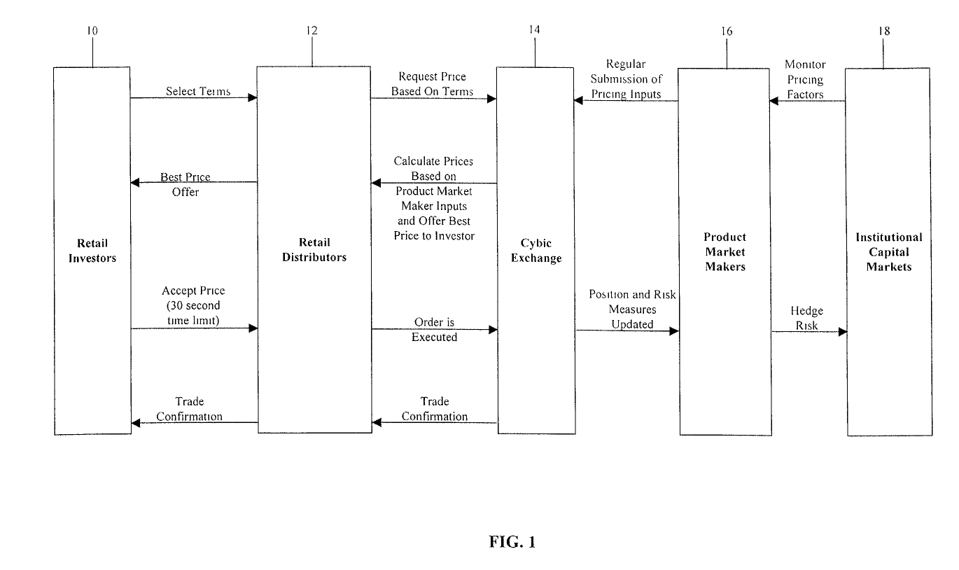

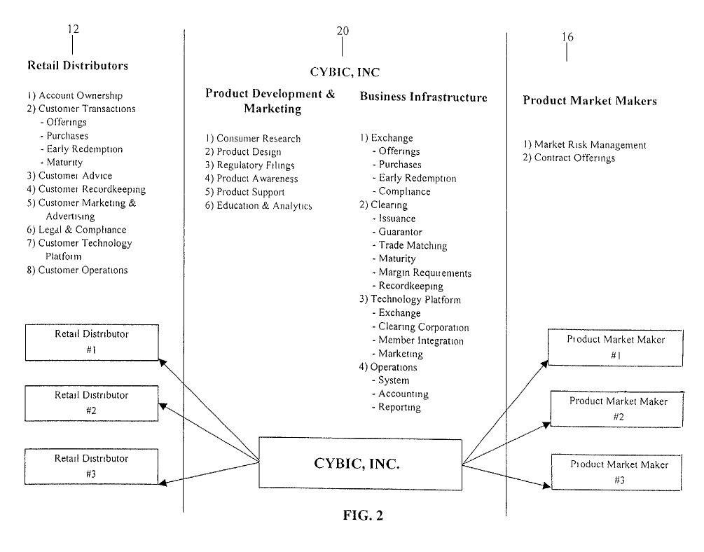

An embodiment of the present invention includes a number of entities and entity roles. FIG. 1 is a schematic flow diagram which illustrates an example of key components and the flow of information between the key components for an embodiment of the present invention. The key components include, for example, Retail Investors 10, Retail Distributors 12, the Cybic Exchange 14, Product Market Makers 16, and Institutional Capital Markets 18. FIG. 2 is a schematic chart which illustrates examples of the general responsibilities of the Product Market Makers 16, the Retail Distributors 12 and Cybic, Inc. 20. Cybic, Inc. 20 is the entity that develops and markets the customizable investment products for an embodiment of the present invention. Cybic, Inc. 20 as used herein also includes its subsidiary, Cybic Exchange, Inc. 14, as well as its other subsidiaries, such as Cybic Clearing Corporation and Cybic Management, Inc., unless otherwise indicated.

The Cybic, Inc. 20 business model for an embodiment of the present invention benefits its Product Market Maker 16 and Retail Distributor 12 partners and the Retail Investors 10 of the Retail Distributors 12. Benefits provided to Retail Distributors 12 include, for example, new innovative products, easy to sell products, a test lab for new products, broker-determined commissions, marketing support, product support, a “turnkey” business infrastructure, coordination of SEC product filings, and minimum development cost versus large potential revenues.

Benefits provided to Retail Investors 10 by an embodiment of the present invention include, for example, customizable investment products, easy to understand products, competitive fees, product support, small uniform investment size which promotes easy building of baskets, and better pricing than currently available for structured solution alternatives. Product Market Makers 16 are provided benefits, such as new profitable Retail Investors 10, efficiency in hedging due to small transaction size and one-sided market, coordination of SEC filings, a test lab for new products, Market Maker-determined spread revenue, a “turnkey” business infrastructure, a buffer to the Retail Investor 10, and minimum development cost versus large potential revenues.

In developing and marketing customizable financial products, Cybic, Inc. 20 for an embodiment of the present invention is uniquely positioned to focus on the individualized investment needs of retail investors, to engineer the product development cycle in order to reduce time to market and allow expedited trial of potential new products, to provide Product Market Makers 16 and Retail Distributors 12 with a complete “low-cost” infrastructure for offering and delivering Cybic products, and to create a business which can be scaled internationally. Cybic, Inc. 20 provides services to Product Market Makers 16 and Retail Distributors 12, such as product development and marketing of customizable retail investment products, and the business infrastructure required by Product Market Makers 16 and Retail Distributors 12 to profitably offer and deliver these products. Cybic, Inc. 20 furnishes product development services, such as consumer research to aid in the design of superior products, product design based on consumer research and Product Market Maker/Retail Distributor feedback, and all regulatory filings needed for Cybic product approval.

An embodiment of the present invention provides products that are designed to directly meet Retail Investors' individual needs. An embodiment of the present invention also provides Retail Investors 10 the ability to customize contract terms and a small, uniform pre-defined dollar unit size that facilitates portfolio diversification. In addition, an embodiment of the present invention enables Retail Investors 10 to directly control risk and reward and provides a product that is very simple to use and that can be understood quickly by a Retail Investor 10. That is an important feature, because, for example, sellers have only one or two minutes to communicate a product's benefits or risk losing the Retail Investors' attention. Thus, product communication for an embodiment of the present invention includes a very short communication goal. Typically, Retail Investors 10 think of their investment portfolios in terms of risk segments, such as aggressive money, savings money, and the like, and Retail Investors 10 are able to quickly understand where Cybic products for an embodiment of the present invention fit.

A premise of an embodiment of the present invention is that one size does not fit all. In other words, each individual product configuration is typically of extreme interest to a certain percentage of Retail Investors 10. An embodiment of the present invention provides products that individually address the needs of targetable segments of the universe of Retail Investors 10, which can collectively add up to a large mass market. An embodiment of the present invention provides Retail Investors 10 more choice in their product alternatives, provides Retail Investors 10 easier access to specific areas, such as interest rates and international equities, as well as commodities and foreign exchange. In addition, an embodiment of the present invention assures that Retail Investors 10 receive the best price from multiple Product Market Makers 16, with a time guarantee on the price. Retail Investors 10 consider the system for an embodiment of the present invention to be preferable to the market or limit order system employed by other exchanges.

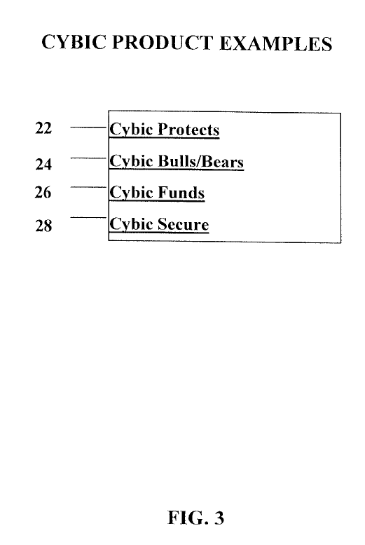

Customizable features of Cybic products for an embodiment of the present invention include, for example, investment size, maturity, risk tolerance, underlying instrument, such as commodities, foreign exchange, interest rate, baskets, and equities, and downside protection. FIG. 3 is a table which illustrates examples of customizable Cybic products for an embodiment of the present invention. Referring to FIG. 3, customizable Cybic products include, for example, CybicProtects 22, CybicBulls/Bears 24, CybicFunds 26, and CybicSecure 28. CybicProtects 22 is an individual equity or equity index contracts with downside protection targeted at Retail Investors 10 seeking high risk equities with some downside protection, or Retail Investors 10 who currently hold positions in risk adverse instruments who are dissatisfied with the low return they must accept for this safety.

CybicBulls/Bears 24 are leveraged individual equities contracts with limited downside targeted at market knowledgeable Retail Investors 10 who are risk tolerant, but are confused by the mechanics of constructing option positions. CybicFunds 26 are equity index contracts similar to index mutual funds which trigger no tax gain/loss until sale, offer an exact index payout plus a contracted premium, and provide real-time pricing. CybicSecure 28 consists of collar protection for use with an existing equity position which provides Retail Investors 10 with downside protection in exchange for upside potential at no “out of pocket” cost.

The CybicProtects 22 product allows Retail Investors 10 to limit the potential loss on an equity or index investment by capping the potential gain. A Retail Investor 10 chooses an underlying equity or index, a number of investment units (e.g., $100 each), a maturity, and a protection level (the “Protection Percentage”). The Retail Investor 10 is then quoted a Return Cap, which represents the maximum potential investor gain. At maturity, the Retail Investor 10 is paid the initial investment compounded by the percent increase or decrease on the underlying equity or index from the time of purchase. The Retail Investor 10 is protected against losses below the Protection Percentage, and may Early Redeem the CybicProtects 22 at any time for an interim price competitively quoted by the Product Market Makers 16.

As an example of a CybicProtects 22 product, assume that the Retail Investor 10 purchases on Feb. 14, 2000 a single unit ($100) of a one-year IBM CybicProtect 22 and chooses a Protection Percentage of ninety percent. The Return Cap is quoted at seventeen percent, and IBM is selling for $120 per share. If, for example, IBM closes at $132 (a ten percent increase) on Feb. 14, 2001, the Retail Investor 10 receives a return of ten percent (gain) times $100, or $10 plus the initial investment of $100, for a total of $110. If IBM closes at $144 (a twenty percent increase) on Feb. 14, 2001, because the gain is greater than the Return Cap of seventeen percent, the Retail Investor's gain is limited to seventeen percent of the initial investment. In dollar terms, this is $17 in addition to the initial $100 investment, for a total of $117. If IBM closes at $120 (a zero percent increase/decrease) on Feb. 14, 2001, the Retail Investor 10 receives the initial investment of $100.

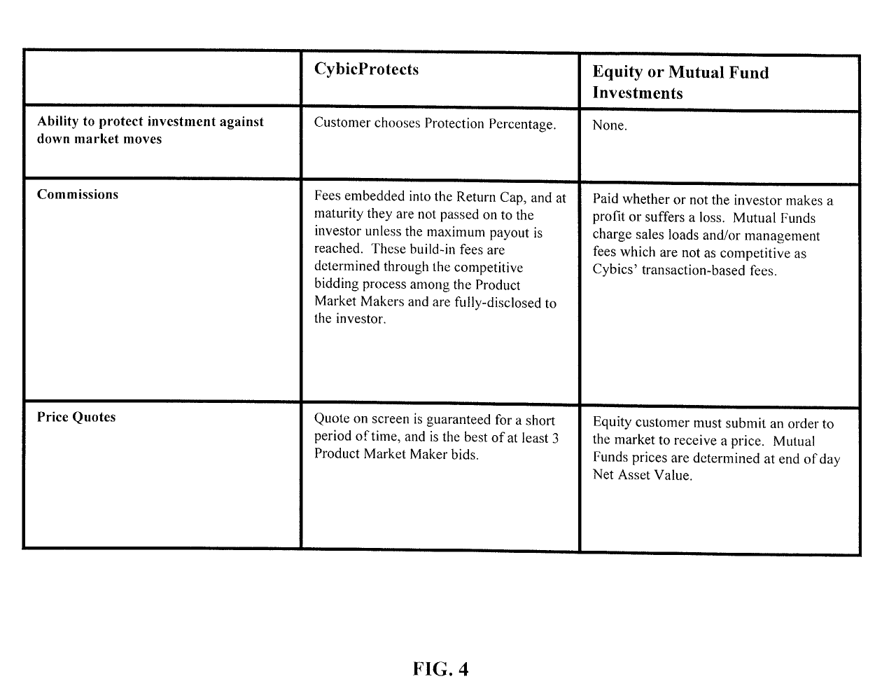

Continuing with the foregoing CybicProtects 22 example, if IBM closes at $114 (a five percent decrease) on Feb. 14, 2001, the Retail Investor 10 loses five percent of the initial $100 investment. In dollar terms, the Retail Investor 10 is returned the initial $100 investment less a $5 loss, for a total of $95. If IBM closes at $96 (a twenty percent decrease) on Feb. 14, 2001, because the loss results in a decline below the Protection Percentage of ninety percent, the Retail Investor 10 loses only ten percent of the initial $100 investment. In dollar terms, the Retail Investor 10 is returned the initial $100 investment less a $10 loss, for a total of $90. FIG. 4 is a table which shows an example of comparisons of the benefits of the CybicProtects 22 product to equities or mutual fund instruments, which are the closest standard retail product available today.

The CybicBull/Bear 24 product for an embodiment of the present invention allows the Retail Investor 10 to increase the potential gain or loss of an investment by a multiple of the Retail Investor's choosing. The Retail Investor 10 chooses an underlying equity or index, the number of investment units (e.g., $100 each), a maturity, and a leverage factor (Return Multiplier). The Retail Investor 10 is then quoted a Return Cap, which represents the maximum potential investor gain. For a CybicBull 24, at maturity the Retail Investor 10 is paid the initial investment compounded by the percent increase or decrease on the underlying equity or index (from the time of purchase) times the Return Multiplier. The Retail Investor 10 can lose no more than the initial investment, and may Early Redeem the CybicBull 24 at any time for an interim price competitively quoted by the Product Market Makers 16. CybicBears 24 work in the opposite direction of CybicBulls 24, leveraging positive returns when the market is declining and leveraging loses when the market is going up.

As an example of a CybicBull 24, assume that on Feb. 14, 2000, the Retail Investor 10 purchases a single unit ($100) of a six-month IBM CybicBull 24 and chooses a Return Multiplier of ten. The Return Cap is quoted at eighty percent, and IBM is selling for $120 per share at the time of purchase. If IBM closes at $126 (a five percent increase) on Aug. 14, 2000, the Retail Investor 10 receives a return of ten (Return Multiplier) times five percent (increase in underlying price) or a fifty percent return on the initial investment of $100, for a total of $150. If IBM closes at $144 (a twenty percent increase) on Aug. 14, 2000, the preliminary return calculation produces ten (Return Multiplier) times twenty percent (increase in underlying price) or a two hundred percent return on the initial investment. This is greater than the Return Cap of eighty percent, and therefore the Retail Investor 10 is paid the eighty percent Return Cap on the initial investment of $100, for a total of $180. If IBM closes at $120 on Aug. 14, 2000, the Retail Investor 10 receives the initial investment of $100.

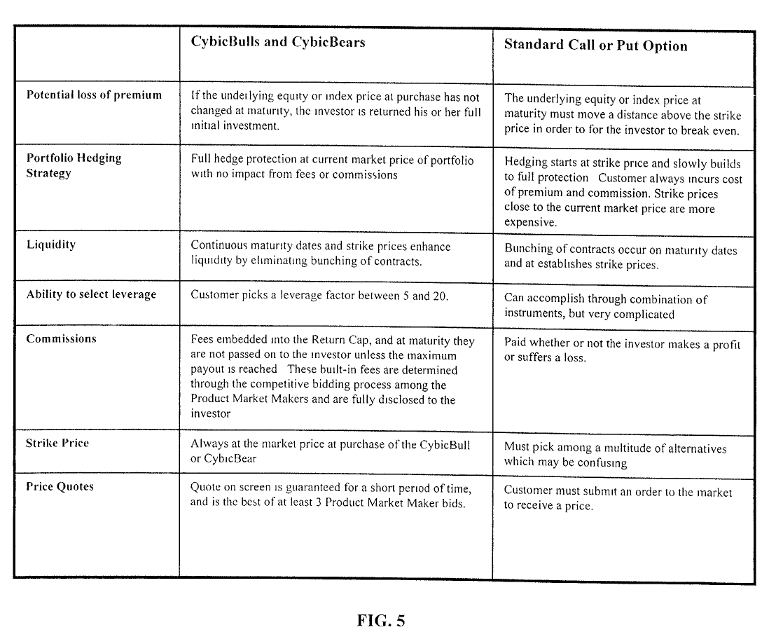

In the foregoing CybicBull 24 example, if IBM closes at $114 (a five percent decrease) on Aug. 14, 2000, the Retail Investor 10 loses ten (Return Multiplier) times 5 percent (decrease in underlying price) or fifty percent from the initial investment of $100, for a total return of $50. If IBM closes at $96 (a twenty percent decrease) on Aug. 14, 2000, the preliminary return calculation produces ten (Return Multiplier) times twenty percent (decrease in underlying price) or 200 percent. However, the Retail Investor 10 can never lose more than the initial so only $100 is lost. FIG. 5 is a table which shows an example of a comparison of benefits of CybicBulls/Bears 24 for an embodiment of the present invention to standard put and call options.

CybicFunds 26 for an embodiment of the present invention allow the Retail Investor 10 to invest in an index fund that triggers no tax gain/loss until sale, offers an exact index payout plus dividends, and provides real-time pricing. The Retail Investor 10 chooses an index and a dollar amount to invest. The Retail Investor 10 is then quoted the lowest management fees of at least three Product Market Makers 16. The Retail Investor 10 may redeem the CybicFund 26 at anytime for the initial investment, the actual increase/decrease in the index, and all actual dividends paid on the underlying index from the date of purchase. Annual Management Fees, which include exchange and retail distribution fees, are assessed for each year or part of a year that the investment is held.

For an example of a CybicFund 26, assume that on Feb. 14, 2000 the Retail Investor 10 buys $1000 of the S&P 500 CybicFund. The Retail Investor 10 is promised a payout of the S&P 500 plus actual dividends, and the Management Fee is quoted at one percent. If on Feb. 14, 2001 the Retail Investor 10 sells the fund, and if the S&P 500 has increased over the period of ownership by ten percent and actual dividends on the S&P 500 over this period are two percent, the Retail Investor 10 is paid the $1000 investment, plus the ten percent increase in the S&P 500 ($100), plus two percent dividends ($20), less the one percent Management Fee ($10), for a total return of $1,110. In the same CybicFund example, if on Aug. 14, 2001 the Retail Investor 10 sells the fund, and if the S&P 500 has increased over the period of ownership by fifteen percent and actual dividends on the S&P 500 over this period are three percent, the Retail Investor 10 is paid the $1,000 investment, plus the fifteen percent increase in the S&P 500 ($150), plus three percent dividends ($30), less the one percent Management Fee for a full two years ($20), for a total return of $1,160. All tax recognition for the Retail Investor 10 occurs on the date of sale.

The CybicSecure 28 for an embodiment of the present invention allows the Retail Investor 10 to wrap a protection collar around an existing equity position at no out-of-pocket cost. The Retail Investor 10 chooses an existing equity position to protect, a number of shares to protect, a protection level (Protection Percentage), and a period of time for protection. The Retail Investor 10 is then quoted a Return Cap, which represents the maximum potential investor gain on the existing position. At maturity, if the equity position value is below the Protection Percentage, the Retail Investor 10 is paid the difference in cash. If the equity position value is above the Return Cap, the Retail Investor 10 pays the difference in cash or the equity position is partially liquidated.

For an example of a CybicSecure 28, assume that on Feb. 14, 2000 the Retail Investor 10 owns IBM stock worth $1,200 (ten shares) and wishes to protect ninety percent of this entire position for one year. The Return Cap is quoted at seventeen percent, and IBM is selling for $120 per share. If IBM closes at $132 (a ten percent increase) on Feb. 14, 2001, the Retail Investor 10 receives or owes nothing. If IBM closes at $144 (a twenty percent increase) on Feb. 14, 2001, because the gain is greater than the Return Cap of seventeen percent, the Retail Investor 10 owes Cybic, Inc. 20 three percent of the equity position at purchase, or $36, which is removed from the cash account of the Retail Investor 10. In the foregoing CybicSecure example, if IBM closes at $120 (a zero percent increase/decrease) on Feb. 14, 2001, the Retail Investor 10 receives or owes nothing. If IBM closes at $114 (a five percent decrease) on Feb. 14, 2001, the Retail Investor 10 receives or owes nothing. If IBM closes at $96 (a twenty percent decrease) on Feb. 14, 2001, because the Protection Percentage was set at ninety percent, Cybic, Inc. 20 pays the Retail Investor 10 ten percent of the equity position value at purchase, or $120 in cash.

In an embodiment of the present invention, Cybic, Inc. 20 provides for a Retail Distributor-determined fixed fee per investment unit by product, a Product Market Maker-determined volatility bid-ask spread for each product, underlying, maturity, and strike, and a Cybic Exchange transaction fee by product. For CybicBulls/Bears 24, CybicProtects 22, and CybicSecure 28, all fees are built into the Return Cap and are not added to the investment cost. For an example regarding CybicBull fees, assume that the Product Market Maker volatility bid-ask is $0.75-$0.75, that the Retail Broker fee per unit for three months is $2.00, that the Cybic fee per unit for three months is $1.50, that the Return Cap without fees is ninety percent, and that the quoted Return Cap with fees is eighty percent. In this example, had there been no fees, the Return Cap would be ninety percent, but because there are fees of three and one-half percent, the Product Market Maker 16 receives net proceeds of $96.50 in which to hedge the CybicBull 24. Given the promised payout structure, the Product Market Maker 16 sells calls at a lower strike price than if the Product Market Maker 16 had received $100 of proceeds, which translates to a lower promised Return Cap at maturity of eighty percent.

In an embodiment of the present invention, Product Market Makers 16 offer and manage their Cybic positions, and Retail Distributors 12 sell the Cybic products to Retail Investors 10. Cybic, Inc. 20 provides an Exchange 14 for the offering, purchase, early redemption, and sale of Cybic products, provides a clearing capability to issue, guarantee, and manage margins for Cybic products, provides a technology platform which can be integrated into the existing infrastructures of Product Market Makers 16 and Retail Distributors 12, and provides an operations unit to handle daily system, accounting, and reporting requirements.

In an aspect of an embodiment of the present invention, an Options Clearing Corporation issues and guarantees all Cybic products. When a purchase transaction is executed, the Options Clearing Corporation establishes a contract between itself and the Retail Distributor 12, and the Options Clearing Corporation also establishes an identical and offsetting transaction between itself and the Product Market Maker 16. The Options Clearing Corporation guarantees all obligations under the contract, and has the proper credit and margining rules in place to cover its liability. The Options Clearing Corporation provides Product Market Makers 16 and Retail Distributors 12 with the ability to cross margin with existing Options Clearing Corporation products. In order to eliminate the need for reconciliation, Cybic Management, Inc. maintains complete transaction records for Cybic products for the Options Clearing Corporation, the product Market Maker 16, and the Retail Distributor 12. Cybic Management, Inc. develops all margining models on behalf of the Options Clearing Corporation to the specifications of the Options Clearing Corporation, and the Options Clearing Corporation is responsible for determining the pricing inputs for all Cybic, Inc. “mark-to-market” valuations.

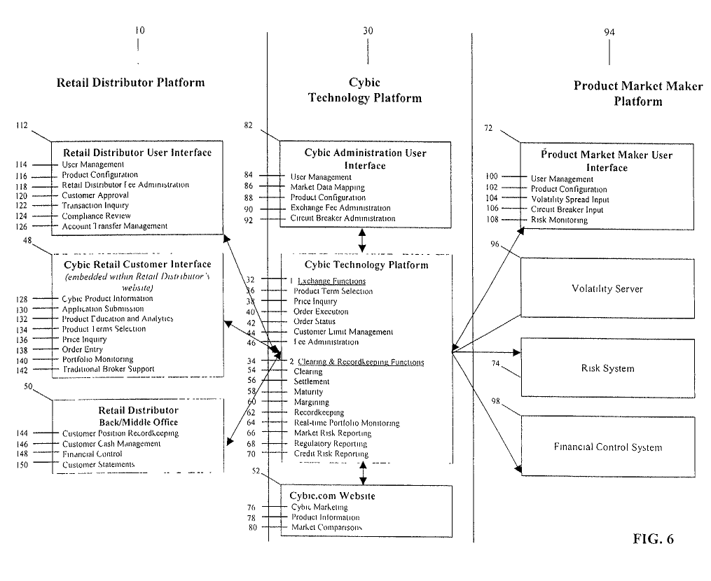

FIG. 6 is a schematic diagram which illustrates aspects of the Cybic technology platform for an embodiment of the present invention and examples of functional systems with which the Cybic technology platform interfaces. Major advantages of the Cybic technology platform 30 are its “straight through processing” capabilities and its component design. Today, the traditional investment product processing flow is fragmented among many participants and is highly inefficient. Many reconciliations are needed to keep all the participants synchronized. The Cybic technology platform 30 eliminates the need for many operational participants, and places all processes in one place with one database. This greatly reduces the potential for operational errors and keeps costs low.

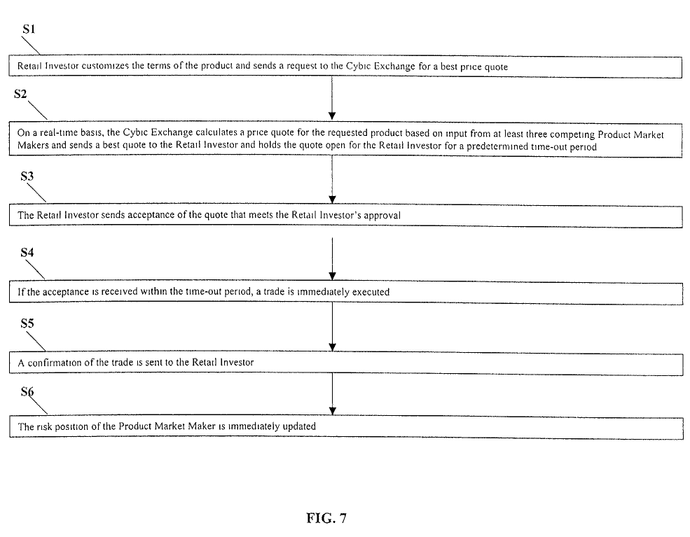

The Cybic Exchange technology platform 30 is novel in its approach. FIG. 7 is a flow chart which illustrates an example of the process of investing in a customized Cybic product for an embodiment of the present invention. Referring to FIG. 7, at S1, a Retail Investor 10 customizes the terms of the product and sends a request to the Cybic Exchange 14 for a price. At S2, on a real-time basis, the Cybic Exchange 14 calculates a price for the requested product based on input from at least three Product Market Makers 16. Also, at S2, the Retail Investor 10 is offered the best price and has a pre-determined time-out period, such as thirty seconds, from the time the quote leaves the Cybic Exchange's server to purchase the Cybic product at the offered price. If the Retail Investor 10 purchases the Cybic product at S3, the order is immediately filled at S4, the Retail Investor 10 receives a confirmation at S5, and the risk position of the Product Market Maker 16 is immediately updated at S6.

Referring again to FIG. 6, the Cybic technology platform 30 performs, for example, exchange functions 32 and clearing and record keeping functions 34. Both exchange functions 32 and clearing and record keeping functions 34 are centralized, with the Product Market Makers 16 and the Retail Distributors 12 linking to a single source of information. In an embodiment of the present invention, Cybic, Inc. 20 integrates its technology into the systems of Product Market Makers 16, Retail Distributors 12, the Options Clearing Corporation, and the NASDR. The Cybic technology platform 30 utilizes common FIX messaging, and Cybic, Inc. 20 makes the connections to its participant's accounting, risk management, pricing model input (volatility), and Retail Investor record-keeping systems. In addition, Cybic, Inc. 20 provides the retail HTML interface and connections for Cybic products. Retail Distributors 12 can brand the interface.

On a daily basis, Cybic, Inc. 20 operates the Cybic technology platform 30, books all accounting entries, and provides all reporting required by Product Market Makers 16, Retail Distributors 12, the Options Clearing Corporation, and the NASDR. Exchange functions 32 are concerned with the offering and execution of Retail Investor orders. Referring further to FIG. 7, at S1, the Retail Investor 10 sends a “request for quote” to the Exchange 14, and at S2, the Exchange 14 uses a real-time pricing model to return the best price to the Retail Investors 10 based on inputs from competing Product Market Makers 16. Exchange functions 32 also include the execution of purchase and early redemption requests, cash settlement of contracts at maturity, and other administrative duties.

Clearing and record keeping functions 34 are initiated after an execution occurs on the Exchange 14. The transaction must be booked and a message sent to the Retail Distributor 12 and Product Market Maker 16 indicating that a transaction has taken place. Net cash due/owed must be tabulated at the end of the day. Record keeping functions, such as market risk, credit risk and regulatory reporting must be performed on a real-time basis. In addition, it is not possible for most Retail Distributors 12 to directly deliver real-time portfolio valuation, so Cybic, Inc. 20 performs this function.

The exchange functions 32 of the Cybic technology platform 30 can be grouped, for example, as Product Term Selection 36, price Inquiry 38, Order Execution 40, Order Status 42, Customer Limit Management 44, and Fee Administration 46. With regard to product Term Selection 36, the Cybic technology platform 30 provides a list of Cybic products available for purchasing in real time. Dependent upon the structure of the product, the offering list is provided in multiple steps. The usual first step is the list of products. Once a Retail Investor 10 chooses a product from the list, the Retail Investor 10 can ask for the classes of that product. After this, the Retail Investor 10 configures one or more product terms. This process continues until the product structure does not allow further branching. Then the Retail Investor 10 can choose to get an indicative quote or buy one or more contracts.

Price Inquiry 38 for an embodiment of the present invention includes, for example, offering quotes, redemption quotes, and maturity value. With respect to offering quotes, since Cybic products are customizable, there are a great number of product configurations available on the Exchange 14. The offering quotes of these configurations are not stored in an offering table as in a traditional exchange. Referring once more to FIG. 7, at S2, upon receiving a quote request, a pricing engine of the Exchange 14 takes equity prices and interest rates from the designated market data vendor and real-time volatility inputs, including market volatilities and bid and offer volatility spreads, from all Product Market Makers 16. The pricing engine then determines the best price and sends it to the Retail Investor 10.

There are two types of offering quotes for an embodiment of the present invention, namely, indicative quotes and firm quotes. Anyone may query the system to get as many indicative quotes as desired through the Cybic Retail Customer Interface 48 and through Cybic.com 52. When a Retail Investor 10 wants to purchase a Cybic product, a “request for quote” is sent to the Exchange 14. The Exchange 14 first checks to make sure the Retail Investor 10 is approved to trade in the product for which the quote is requested. If the Retail Investor 10 is not approved, the “request for quote” is rejected, and the Retail Investor 10 is notified to contact the Retail Investor's broker. The Exchange 14 stores all firm quotes along with the second and third best offering quotes, as well as the pricing environments for auditing and customer service purposes.

Redemption quotes work in a similar manner to offering quotes. A Retail Investor 10 sends in a request for quote for an outstanding contract in the Retail Investor's holdings. Based on the current volatility inputs of the Product Market Makers 16, real-time market data, and the terms of the contract, the pricing engine generates redemption quotes for all the Product Market Makers 16. The best quote is then sent to the Retail Investor 10, with the second and third best quotes as well as pricing environments stored on the Exchange 14 in anticipation of an audit and for service purposes. The same two quote types, indicative and firm, are offered as offering quotes.

The maturity value of an expiring contract is calculated as specified by the payoff formula in the contract. Its calculation is performed in an end-of-day batch process after the market is closed on the day it matures and references closing prices of the relevant securities. Besides providing offering quotes, redemption quotes and maturity values, the price Inquiry function 38 of the Exchange 14 is very flexible, so that products and pricing models can be plugged or unplugged independently and rather quickly. Instead of using proprietary pricing models, the price Inquiry function 38 employs standard pricing models such as the Black-Scholes. Product Market Makers 16 are expected to convert all inputs and prices from their own proprietary formats to the standard-formats.

With regard to Order Execution 40, the Exchange 14 receives Retail Investor orders for Cybic products from the Retail Distributors 12. All orders are communicated electronically to the Exchange 14 via the Cybic Retail Customer Interface 48. The Exchange 14 accepts only two order types for purchases and early redemptions, which are guaranteed quote orders and fill-or-kill orders. For guaranteed quote orders, the Retail Investor 10 submits a “request for quote.” The Exchange 14 replies with a firm quote with a time stamp. If the Retail Investor 10 accepts the quote within the time limit, the Exchange 14 executes the order. Preferably, the limit is, for example, thirty seconds from the time the quote leaves the Exchange 14 to the time it is received and filled on the Exchange 14. Fill-or-kill orders are an emergency type of order when the guaranteed quote fails due to Internet network delays. The Exchange 14 matches the order with the best current price from the Product Market Makers 16 and then executes, if within the limit specified. If the Exchange 14 cannot execute within the limit specified, the order is rejected.

For purchases, the order amount must not exceed the Retail Investor's account limit. The Exchange 14 queries the Retail Distributor's Middle Office 50 for the Retail Investor's account limit. The account limit is, for example, the current cash on hand, but it can be some other number which is provided. In addition, the Exchange 14 makes sure that the maximum exposure caused by the purchase does not exceed the Retail Investor's current trading limit. The current trading limit is equity the scorecard trading limit minus the maximum possible loss from current outstandings. For early redemptions, the order amount must not exceed the quantity owned by the Retail Investor 10, since the Exchange 14 does not support short selling. As soon as an order is successfully received on the Exchange 14, an order status record is created. Once an order is filled or rejected, the order status is updated accordingly. Retail Investors 10 may see the current status of all orders that they placed that day via the Cybic Retail Customer Interface 48.

For Customer Limit Management 44, the Exchange 14 provides a technology solution to help Retail Distributors 12 in managing trading approvals and trade limits on Cybic products. This is done through the use of an electronic scorecard, which the Retail Investor 10 takes upon signing up with the Cybic system for an embodiment of the present invention. The scorecard consists of various “Know Your Customer” questions. Each Retail Distributor 12 can assign point values and weights to the questions of the scorecard or accept the Exchange's default values. A Retail Investor's trade limit is determined based on the score the Retail Investor 10 receives. A compliance registered options principle at the Retail Distributor 12 can override this limit at any time as long as the reason for doing so is documented. The trade limit is checked before each purchase to ensure compliance. Accounts are suspended from further purchases once the trade limit has been reached.

With respect to Fee Administration 46, the Exchange 14 and the Retail Distributor 12 each enter fixed transaction fees by product. For CybicBulls/Bears 24 and CybicProtects 22, these fees are generally built into the price rather than charged explicitly. This means that fees become one of the inputs into the pricing model. Transaction fees are charged for purchases and early redemptions, and not at the maturity of a contract. Product Market Makers 16 add their fees through volatility inputs.

Clearing and Record Keeping functions 34 of the Cybic technology platform can be grouped, for example, to include Clearing 54, Settlement 56, Maturity 58, Margining 60, Record Keeping 62, Real-time portfolio Monitoring 64, Market Risk Reporting 66, Regulatory Reporting 68, and Credit Risk Reporting 70. Clearing 54 happens continuously whenever a transaction occurs. The Clearing Corporation guarantees the back-to-back contracts with the Retail Distributor 12 and the Product Market Maker 16 for each trade. Settlement is when cash changes hands. For the Clearing Corporation it is, for example, the day after the trade date (T+1). Settlement reports are created nightly and sent to the appropriate operations personnel working for Cybic 20 and for members. Payments are due in the Cybic Clearing settlement account, for example, by a predetermined time on the next business day. Payment between the Retail Distributor 12 and the Product Market Maker 16 and the Clearing Corporation is guaranteed at the time of purchase or sale of a contract.

The official books and records for the Exchange 14 are maintained by the Cybic technology platform 30. All contract creation and maintenance, transaction booking, batch processing and other administrative functions are performed by the Cybic technology platform 30. Aspects of Record Keeping 62 include, for example, post transaction processing, batch processing, MIS, transfers, and error correction. With regard to post transaction processing, for filled orders, contract and holding records are created and maintained by the Cybic technology platform 30. Contracts can early redeemed, and the new position is updated in real-time. Each filled or rejected order generates a transaction record which is stored.

With respect to batch processing, after the close of each business day, a variety of batch processes are done. The system adjusts contracts, holdings and historical pricing data for corporate actions. The system also marks to market all outstanding contracts based on the “last available price” after a pre-determined cutoff time. The system creates a file containing a summary of all revenue generating activity and posts it to the Cybic general ledger. The system exports a file to each Exchange member consisting of outstanding positions related to each member. There is a different file generated for Retail Distributors 12 and Product Market Makers 16. The Retail Distributor file is summarized by Retail Investor account, and the Product Market Maker file is summarized by product. For MIS, the Cybic technology platform 30 offloads the day's activities into a separate MIS database. This database supports MIS reports and historical inquiries from credit, compliance, operations and the members.

With respect to transfers, the Cybic technology platform 30 processes holdings transfer requests that are entered during the day. Various types of transfers are supported, such as when a trader wishes to transfer outstanding contracts from one portfolio to another, when the Cybic Exchange 14 needs to transfer contracts from one member to another due to a member ceasing to participate in the Exchange 14, and/or when a Retail Investor 10 wishes to transfer all or part of the Investor's holdings from one account to another, either within the same Retail Distributor 12 or to another. The first type is executed in real-time, while the others are processed in batch after the close. If a transfer is initiated by a Retail Investor 10 due to a gift or inheritance, the system adjusts the cost basis accordingly for accurate tax report purposes. Additionally, when a contract is transferred from one Product Market Maker 16 to another, the associated cost basis is adjusted.

In the event of an error, the Exchange operations personnel first attempt to determine the cause of the error and with whom responsibility for the error lies. A determination is then made of the loss or gain. If the loss is unmanageable, for example, such that it will bankrupt the Exchange 14 or one of the members, then the transaction is reversed. If the loss or gain is manageable, the difference is posted to an error account and then settled with the member(s). The Cybic technology platform 30 provides the functionality to mass correct transactions and contracts based on certain criteria.

With respect to Maturity 58, maturing contracts are cash settled in batch at the end of each day for contracts due to mature on that day. A contract matures, for example, at a predetermined time of day on the trade date plus the tenor of the contract. If this date falls on a holiday or weekend, maturity is pushed to the next business day. The latest market prices as of the predetermined cutoff time are used to determine the Retail Investor's maturity value. All contracts are automatically exercised at maturity for cash. Exercise information by Investor is communicated to the Retail Distributor 12, for example, that evening in the nightly export file, and the Retail Distributor 12 decides when actual cash is moved into the individual Investor's account. For Real-time Portfolio Monitoring 64, the Cybic technology platform 30 provides end-of-day closing prices for a Retail Investor's portfolio. A Retail Investor 10 can get real-time values on a contract by contract basis. Portfolios are valued by the early redemption price. It is important to note that the early redemption price includes an early redemption fees. If the contract is held to maturity the value is slightly higher.

The Market Risk Reporting services 66 provided by the Cybic technology platform 30 supplies real-time Cybic risk information, such as Delta, Gamma, Vega and Theta, for Product Market Makers 16. It is calculated at set intervals throughout the day and made available to Product Market Makers 16 through the web-based Product Market Maker User Interface 72. This information can also be fed into Product Market Makers' Risk Servers 74 through FIX messaging. Because of the nature of Cybic product transactions, which often contain large volumes of small contracts that have very diversified maturity dates, market risks are aggregated by products, classes and maturity periods for easy processing.

All information for Regulatory Reporting 68 is available in a system database and the regulatory reports are simply a matter of formatting. For Credit Risk Reporting 70, the Cybic technology platform 30 supports the Clearing Corporation's credit department by computing margin requirements for each of the members and providing an interface for setting credit limits for each member. The model for calculating the daily margin requirements is based on the end of day mark-to-market plus some factor of the maximum likely increase in value (MLIV). A daily report is generated showing each member's margin requirements. Retail Distributors 12 and Product Market Makers 16 are expected to have all cash and securities to margin account by a pre-determined time on the next business day following the batch process. In addition, the Exchange 14 has exposure limits for each member based on the member's credit rating. These limits are monitored closely and when a member exceeds the member's limit for a particular product, the member is asked to suspend trading in it until the member's exposure is reduced.

An embodiment of the present invention includes a corporate web site 52 to advertise Cybic products and give the Cybic Exchange 14 an Internet presence. The Cybic technology platform 30 provides all dynamic content and furnishes potential Retail Investors information, such as Marketing 76, Product Information 78, and Market Comparison 80. The Marketing section 76 contains relevant explanatory information for Cybic product offerings. Additionally, instructions are provided on how to begin using Cybic products with links to member Retail Distributors 12. For Product Information 78, the Cybic web site 52 provides a list of offered product terms in real time. Since it is possible that during the course of the day a product term is suspended or activated resulting from Exchange or Product Market Maker initiated actions, this function provides a real-time list of what product terms are currently available and what are not. Potential Investor's are able to see end-of-day volumes and prices from the previous trading day for each product and class in an easy-to-read format. It also includes prior day end-of-day volatility information, listed by products, classes, maturity dates and Product Market Makers 16, to provide pricing transparency.

In addition, the web site 52 provides educational materials on Cybic products. They include explanations on contracts and the terms of the payoff formulas. As part of the product analytics, “what-if” scenarios are introduced to help Retail Investors 10 understand the risks and returns involved with various Cybic products. Retail Investors 10 are able to see how they might have fared had they purchased a particular Cybic contract in the past by utilizing historical prices of the reference security. In addition, early redemption scenarios are provided to demonstrate the tradeoffs between redeeming a contract early and holding it to maturity. The web site 52 also keeps track of frequently asked questions and their answers and posts them on a FAQ page. With respect to Market Comparison 80, the Cybic.com web site 52 displays implied market volatilities as calculated from prices of standard options traded on other exchanges. The comparison between this volatility and the volatilities provided by the Product Market Makers 16 helps demonstrate the fairness of the price quotes submitted by Product Market Makers 16 during the previous trading day.

A Cybic Exchange Administration User Interface 82 is an Intranet application through which various Cybic personnel can interact with the Cybic technology platform 30. The basic function groups provided by this Interface 82 include, for example, User Management 84, Market Data Mapping 86, Product Configuration 88, Exchange Fee Administration 90, and Circuit Breaker Administration 92. Exchange User Management 84 allows the setup and management of Exchange users, including the input of user information, the setup and modification of user passwords and the designation of user privileges on the Exchange 14. Four different types of Exchange users include, for example, administrators, operators, financial controllers and compliance officers.

Administrators give other Exchange users access to the Exchange 14, set up Product Market Makers 16 and Retail Distributors 12, and set up Product Market Makers' and Retail Distributors' own administrators. Operators map market data, control Exchange wide circuit breakers, suspend and activate Cybic product trading, implement Exchange transaction fee schedules, input cash dividends and corporate action schedules, run end-of-day batch processes, and perform backup and other operational duties. Financial controllers prepare reports on the Exchange's financial performance and conduct internal audits on the Exchange's financial statements. Compliance officers monitor trading activities as they happen and run reports whenever needed to enforce Exchange members' compliance with the Exchange's constitution and rules. The Market Data Mapping service 86 provides functions for the mapping of market data that Cybic products use. The real-time market data needed for the pricing and re-evaluation of Cybic products include domestic and international equities, equity indices, exchange-traded equity and index options, interest rates, Eurodollar futures contracts, and forecast dividend information for each equity and equity index. With these data, the Cybic technology platform 30 further calculates interpolated interest rates to be used by the pricing engines.

Exchange Product Configuration 88 prepares Cybic products for trading at the Exchange 14. Once a Cybic product is fully developed and plugged into the Cybic technology platform 30, Exchange operators are responsible for configuring the product by adding product classes and setting up Exchange-wide circuit breakers. After fully configuring a Cybic product on the Exchange 14, an Exchange operator grants trading permissions to individual Product Market Makers 16, whose business managers subsequently assign the products to their product managers. Most Cybic products are configurable at the product and class levels. However, configurations at lower levels, such as contract tenors, are also available on a product-by-product basis, if allowed by the product structure. In addition, an Exchange operator can suspend and activate trading at both the product and class levels. At the product level, the Exchange operator can suspend and activate a product either across all the Product Market Makers 16 or for a specific Product Market Maker only. The Exchange operator's suspension and activation of a product class, however, always applies across all the Product Market Makers 16.

For Exchange Fee Administration 90, various fees are set through the user interface 82 on a product by product basis. An Exchange operator implements transaction fees, fees for transferring accounts and other fees. With respect to Circuit Breaker Administration 92, circuit breakers are activated when extreme market conditions or faulty inputs lead to extremely high or low pricing parameters and pricing quotes. These circuit breakers reside at the class level with an Exchange-established set and a Product Market Maker Class Manager-established set. Whenever the Exchange 14 modifies its set of circuit breakers, so that private circuit breakers of the Product Market Makers 16 may become inconsistent with the ones for the Exchange 14, a batch process is run at the end of the day to ensure that circuit breakers of Product Market Makers 16 stay within the new Exchange limits. The private circuit breakers, however, remain effective for the rest of the day until such a batch process is run. An example of the circuit breakers is the upper volatility limit of the reference security. If there is a disruptive event on the market of the reference security and the volatility of the reference security exceeds the upper limit specified by the Exchange 14 or the class manager, the trading of the product class is automatically suspended. The trading of that product class is automatically resumed when the volatility of the reference security returns to normal levels.

An embodiment of the present invention utilizes a Cash Management and Margining system. The interface to the Cash Management system can be, for example, a manual interface. Each evening the Cybic technology platform 30 calculates and nets all cash due to/from each Retail Distributor 12 and Product Market Maker 16. This netted cash amount is made available to each Retail Distributor 12 and Product Market Maker 16 by a pre-determined time of the next business day following the trade date. The Retail Distributor 12 and Product Market Maker 16 must move all cash due to the Exchange 14 by a pre-determined time on the next business day following the trade date to the Exchange clearing account. The Exchange 14 must move all cash due to its members'clearing accounts by a pre-determined time on the next business day following the trade date. In addition, margin requirements are calculated by a pre-determined time of the next business day following the trade date and proper margin must be posted to the member's margin account by a pre-determined time of the next business day following the trade date.

A Product Market Maker technology platform 94 includes, for example, the Product Market Maker User Interface, 72 a Volatility Server Interface 96, a Risk Server Interface 74, and a Financial Control System 98. The Cybic technology platform 30 communicates with participating Product Market Makers 16 through three interfaces, namely the HTTP-based Product Market Maker User Interface 72, the FIX-based Volatility Server Interface 96 and the FIX-based Risk Server Interface 74. The Product Market Maker User Interface 72 is a web-based interface through a dedicated extranet. Functions which Product Market Maker users are able to perform through the Product Market Maker User Interface 72 include, for example, User Management 100, Product Configuration 102, Volatility Spread Input 104, Circuit Breaker Input 106, and Risk Monitoring 108.

Product Market Maker User Management 100 allows the setup and management of Product Market Makers' users, including the input of user information, the setup and modification of user passwords and the designation of user privileges in gaining access to the Exchange 14 on behalf of the Product Market Maker 16. Four types of users in a Product Market Maker 16 include, for example, administrators, business managers, product managers and class managers. Administrators are responsible for adding Product Market Maker's authorized users into the Cybic technology platform database and assigning an approved business manager for the Product Market Maker 16. Business managers are in charge of all the Cybic products for the Product Market Maker 16. The business managers must appoint a product manager for each product, and those product managers must further appoint class managers to make market on various classes of the product. It is the class managers' responsibility, however, to provide product pricing parameters to the Cybic technology platform 30. Business managers, product managers and class managers can appoint delegates to act on their behalf.

The Product Market Maker Product Configuration process 102 involves the selection of product classes the Product Market Maker 16 intends to trade, the specification of values of its private circuit breakers, the specification of risk portfolios and the clearing sub-account. With trading permissions granted by the Exchange 14, a product manager activates the product classes by assigning them to class managers. The class managers can then customize the circuit breakers at will as long as those circuit breakers are more restrictive than their counterparts on the Exchange 14. A product or class manager can suspend or activate the trading of a product or class.

With regard to Volatility Spread Input 104, different volatility inputs from different Product Market Makers 16 lead to different price quotes. In general, volatility inputs have two components, including the base volatilities and the volatility spreads. The Product Marker Maker User Interface 72 provides a facility for class managers to enter the spread portion of the volatility input. The Cybic technology platform 30 provides, in the format of web pages, a list of strike prices and maturity dates of currently actively traded options on Cybic's underlying securities. For each strike price and tenor, class managers are to fill in a bid and an offer volatility spread, using “+” to indicate a positive and “−” to indicate a negative spread. These spreads are then sent to the Cybic technology platform 30 for product pricing. Markups of Product Market Makers 16 are implicitly built into the bid and offer volatility spreads.

With respect to Circuit Breaker Input 106, as described previously, circuit breakers are activated when extreme market conditions or faulty inputs lead to erratic pricing quotes. Class managers can establish their own private circuit breakers in addition to circuit breakers established by the Exchange 14. However, these private circuit breakers are always more restrictive than the ones set up by the Exchange 14. A modification of values of circuit breakers by the Exchange 14 can trigger the modification of the private circuit breakers, provided the values of those private circuit breakers have become less restrictive than the ones set by the Exchange 14 as a result. Regarding Risk Monitoring 108, risk information of Cybic products can be fed into Product Market Makers' Risk Servers 74 through FIX messaging. Alternately, Product Market Makers 16 can receive real-time risk information interactively in HTML format, where the Exchange 14 specifies the standard risk grids in products, classes and tenor periods for Delta, Gamma, Vega and Theta. Product Market Makers 16 can retrieve real-time customized risk reports in the configurations they desire.

With respect to the Volatility Server Interface 96, the Product Market Makers 16 have the option of maintaining a Volatility Server 96 on their premises. It supplies the Cybic technology platform 30 the base volatility portion of the volatility input through FIX messaging, if the Product Market Maker 16 decides not to use the basic volatility surface supplied by the Exchange 14. Where the Cybic technology platform 30 expects midpoint volatility surfaces expressed in certain formats, Product Market Makers 16 may have to convert the output of their current Volatility Server 96 to conform to the requirements of the Cybic technology platform 30. An additional conversion may be needed to prepare the data for transferring through FIX messaging. If a Product Market Maker 16 prefers, the Exchange 14 supplies a Cybic technology platform-calculated implied volatility surface as the default base volatility surface of the Product Market Maker 16. Volatility spreads subsequently entered by the Product Market Maker 16 can help raise or lower the final bid and offer volatilities to the levels desired.

For the Risk Server interface 74, because of the heavy processing requirements of Cybic contracts, all risks for Cybic contracts are calculated by the Cybic technology platform 30. Hedges for Cybic contracts are maintained in product Market Makers' existing institutional user servers. In order to fully understand the net risks relating to Cybic products, Cybic product and hedging risks must be combined. Cybic 14 either transfers Cybic risk positions to the Product Market Maker's Risk Server 74 or the Product Market Maker 16 must transfer its hedging risks to the Cybic technology platform 30. If the Product Market Maker 16 wants margin credit for its hedging positions, it must transfer its hedging risks to the Cybic technology platform 30. Though not preferred, the Cybic technology platform 30 can also transmit Cybic transactions to a Product Market Maker 16 for risk calculation, if that is what the Product Market Maker 16 desires.

With regard to the Financial Control System 98, each evening during the batch process, information is transferred to the accounting systems of the Retail Distributor 12 and Product Market Maker 16 for inclusion in the day's financial records. In the case of the Product Market Maker 16, financial information is aggregated by product. This product information is mapped to the chart of accounts of the Product Market Maker 16 by the Product Market Maker 16. In the case of the Retail Distributor 12, financial information is posted to the individual Investor's account and posted as part of the Retail Distributor's normal nightly posting process.

The Retail Distributor Technology platform 110 consists of the Retail Distributor User Interface 112, the Cybic Retail Customer Interface 48 and the Retail Distributor's own middle and back office systems 50. The Retail Distributor User Interface 112 is a web interface to the Cybic technology platform 30 through which the Retail Distributor 12 can manage its involvement with the Exchange 14. The Cybic Retail Customer Interface 48 is also a web interface through which Retail Investors 10 can transact. This interface is embedded into the Retail Distributor's existing broker interface.

Regarding the Retail Distributor User Interface 112, the Exchange technology platform 30 provides a web-based extranet interface through which Retail Distributors 12 can control product offerings, investigate trading activity of their Retail Investors 10, and manage Retail Investors trading limits. The Cybic technology platform 30 provides an entire Retail Investor approval process through which registered options principals of Retail Distributors 12 can electronically approve their Retail Investors 10 for Cybic product investments. Aspects of the Retail Distributor User Interface 112 include, for example, User Management 114, Product Configuration 116, Retail Distributor Fee Administration 118, Cybic Customer Approval 120, Transaction Inquiry 124, Compliance Review 126, and Account Transfer Management 128.

For User Management 114, Retail Distributors 12 are able to set up and manage their own users. Initially, the Cybic Exchange administrator establishes a Retail Distributor administrator user account for each Retail Distributor 12. Thereafter, the Retail Distributor administrator can set up as many additional users as it may require. Each Retail Distributor 12 must have a minimum number of user accounts, such as a business manager or senior registered options principle (“SROP”), a compliance registered options principle (“CROP”), one or more registered options principles (“ROP”) and one or more operations personnel. The Retail Distributor administrator can set up users and deactivate users for the Retail Distributor 12. Users are able to set and change their own passwords.

The business manager is responsible for the overall Cybic product distribution. The business manager can decide which products to distribute, and in the case of a market emergency, the business manager may temporarily suspend distribution of Cybic products. This function may also be delegated to whomever the business manager chooses. The Cybic technology platform 30 tracks the business manager's delegation assignments. As the SROP, the business manager is responsible for reviewing Retail Investor transactions. ROPs are responsible for approving individual Retail Investor applications to use Cybic products and reviewing Retail Investor transactions. The ROP can over-ride Retail Investor trading limits and approvals. Each override must be documented and the reason for the over-ride must be stated.

The CROP is responsible for configuring and approving the scorecard, reviewing ROP overrides to Retail Investor trade limits, and monitoring approval to Retail Investor applications. The business manager and CROP can delegate their duties to people who are under their direct control. However, they are responsible for overall supervision and control over the activities of their delegates. Retail Distributor operations personnel perform Retail Investor transaction inquiries, as well as such other tasks as need to be performed. The Retail Distributor's business manager is responsible for configuring the Cybic products that the Retail Distributor 12 wishes to distribute. This consists of simply setting the clearing sub-account and activating the product. The Retail Distributor's business manager can set the distribution transaction fee by logging into the Retail Distributor User Interface 112 and setting the fee on the appropriate screen. Fees are set by product.

Each Retail Investor 10 must be approved to trade in each Cybic product by the Retail Distributor's ROP. To aid in this process, the Cybic technology platform 30 has an approval process consisting of the Cybic scorecard, Cybic product quizzes, Cybic disclosure documents, and the approval queue. The Retail Investor 10 must complete the scorecard, take the product quiz, and agree to the Cybic disclosure documents before attaining approval. Approval is granted immediately on a temporary basis if the Retail Investor 10 meets all requirements. The ROP must permanently approve the account before the end of the day, or the approval is withdrawn and the account is suspended.

The Cybic Exchange 14 utilizes an electronic questionnaire or scorecard by which a customer profile for a Retail Investor 10 can be scored. An account trade limit by product is generated based on the score. The scorecard consists of eight questions asking standard “Know Your Customer” questions, such as net worth, income bracket, and the like. The Retail Distributor 12 inputs values for each of the scorecard parameters. These replace Exchange 14 default values. Based on the values entered by the Retail Distributor 12, the scorecard generates a trading limit for the Retail Investor 10. The trading limits are solely the Retail Distributor's responsibility. The CROP of the Retail Distributor 12 is responsible for configuring the scorecard, and only the CROP can change the scorecard parameters or trading limits. The Exchange 14 considers a change initiated by the CROP an approval by the CROP. The Exchange 14 logs every change made to each Retail Distributor's scorecard parameters and trading limits along with the date and time done.

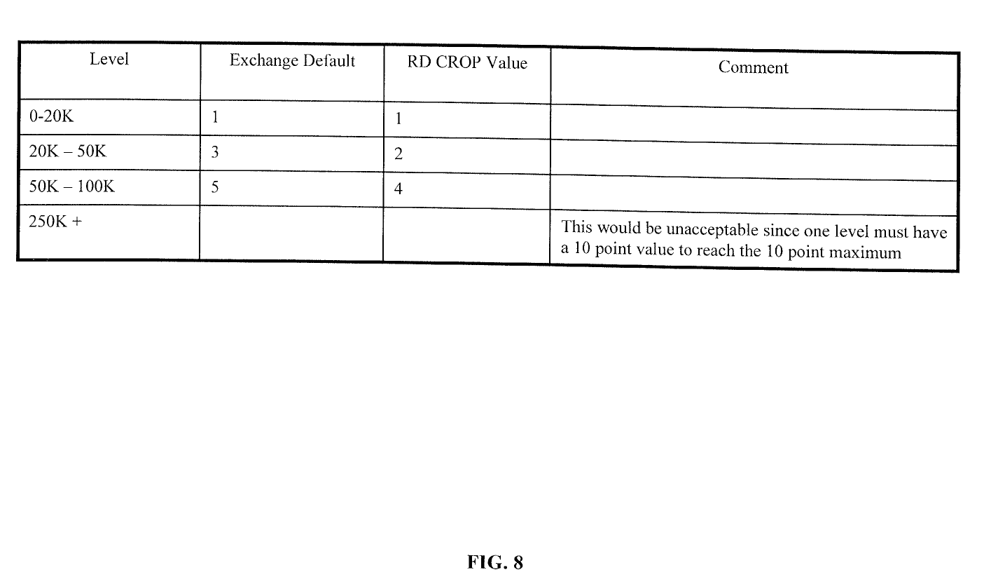

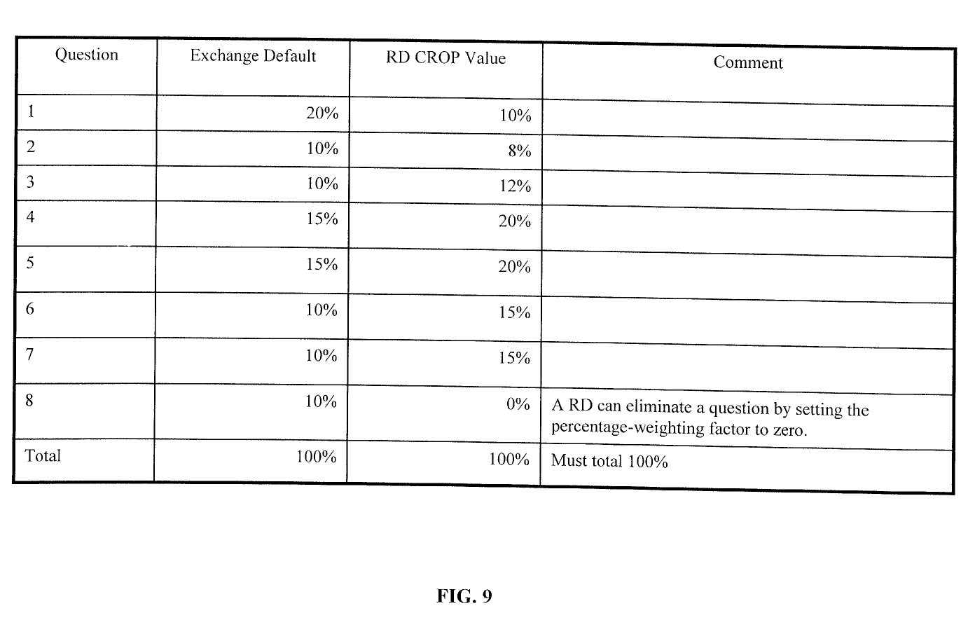

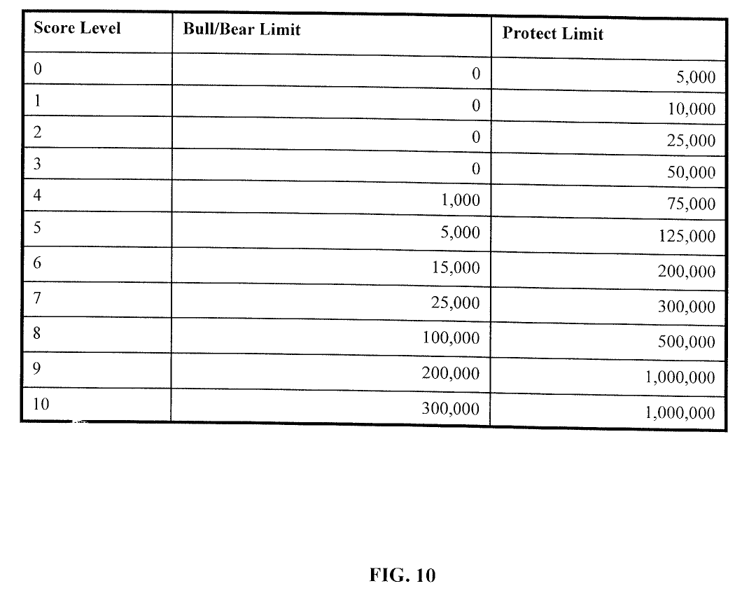

Each scorecard question has a point value of between zero to ten points. The Exchange 14 has a default point value set which the Retail Distributor's CROP can change. Each question, however, must have a maximum possible point value of ten and no less. FIG. 8 is a table which illustrates an example of a question and possible point values for an embodiment of the present invention. Each question has a percentage-weighting factor assigned to it where the total weighting for all questions totals one hundred percent. Again, the Exchange 14 has a default value which can be changed by the Retail Distributor's CROP. FIG. 9 is a table which illustrates an example of percentage weighting factors for the questions for an embodiment of the present invention. The point value of each question is multiplied by the question's percentage-weighting factor to come up with the final score. The final score is a number between zero and ten. The score itself is a decimal, but it is rounded down to the closest integer for assigning trading limits. The CROP at each Retail Distributor 12 assigns a dollar trading limit value to each score level. This is the scorecard trading limit. The Exchange 14 does not suggest a default value. The Exchange 14 does, however, impose a maximum trading limit by account for each product. The CROP assigns a different scorecard trading limit for each product. FIG. 10 is a table which illustrates an example of scoreboard trading limits for particular products.

The Retail Investor 10 enters the Cybic Retail Customer Interface 48, and if the Cybic technology platform 30 determines that the Retail Investor 10 has not applied for trading Cybic products before, the Retail Investor 10 is directed to complete the scorecard. After completion, the scorecard is scored, and the result is sent to the ROP for approval. The Exchange 14 implements an electronic queuing and notification mechanism to obtain approval from the appropriate Retail Distributor's ROP. As noted above, the Retail Distributor's CROP sets a minimum score threshold for each Cybic product, which a Retail Investor 10 must exceed in order to trade. For the Exchange's purposes, a qualifying score is treated as a temporary ROP approval. The trading limit determines whether or not a Retail Investor 10 can trade in the product. If the trading limit is zero, the Retail Investor 10 cannot trade. A ROP may override the scorecard result upon the ROP's discretion and give a Retail Investor 10 approval to trade, even if the Retail Investor 10 scored too low, and vice versa. The Retail Distributor's CROP reviews overrides made by a ROP. Once a year, the Retail Investor 10 is required by the Exchange 14 to review and update the scorecard. However, at any time the Retail Investor 10 may review and update his or her scorecard.

Each Cybic product has product education and a simple quiz to test the Retail Investor's understanding of the product. The Retail Investor 10 must successfully complete the quiz before being approved for trading in the product. The Exchange 14 produces a general Cybic disclosure document detailing the mechanics and risks of investing in all Cybic products. The Exchange 14 makes these available in HTML and downloadable PDF formats. Before the Retail Investor 10 can gain approval, he or she must agree to the statement “I have read and agree to the terms of the Cybic disclosure document”. Whenever the disclosure document is changed or updated by the Exchange 14, each Retail Investor 10 is required to re-read and agree to the new document.

After a Retail Investor 10 has completed an application for trading in a Cybic product, including scorecard, training and quiz, the application goes into an approval queue to await approval by a Retail Distributor ROP. The ROP must log into the system, look over the applications and approve or reject each application. The ROP must approve by the end of the day or the account is suspended. To avoid accounts submitted at the last moment not being approved in time and then becoming suspended, all applications submitted after a predetermined time of day will have until the next day to be approved.

Although the scorecard score determines the Retail Investor's trading limit for that product, the Retail Distributor's ROP can override the trading limit produced by the scorecard. The ROP must document the reason for the override and the reason plus the original trading limit is logged. The Retail Distributor's CROP can review all overrides. If the account application is rejected, or if the ROP fails to act in time, the account is marked as suspended. No new purchase orders can be submitted to the Exchange 14 for suspended accounts. Any open contracts can be early redeemed. If the account is suspended, the Retail Investor 10 can call his or her Retail Distributor 12 to resolve the issue. A capability is provided to recall suspended or rejected applications for ROP or CROP review. The Retail Distributor 12 sends a notification by email to the Retail Investor 10 upon a suspension.

For Transaction Inquiry 122, when the need arises, compliance or operations personnel can investigate Retail Investor transactions by logging into the Retail Distributor User Interface 112 and browsing transactions based on various query parameters such as Retail Investor account number, transaction date, trade date, Cybic product and class. Report outputs may either be printed or downloaded in a comma-delimited format for further analysis. Regarding Compliance Review 124, Retail Distributor ROPs are required to review all Retail Investor transactions by the end of the day. Since no shorting are allowed, only purchase transactions are displayed. The ROPs may review by logging into the system and selecting the Cybic transaction review screens. The ROPs have until a predetermined time the next business day to complete this task.

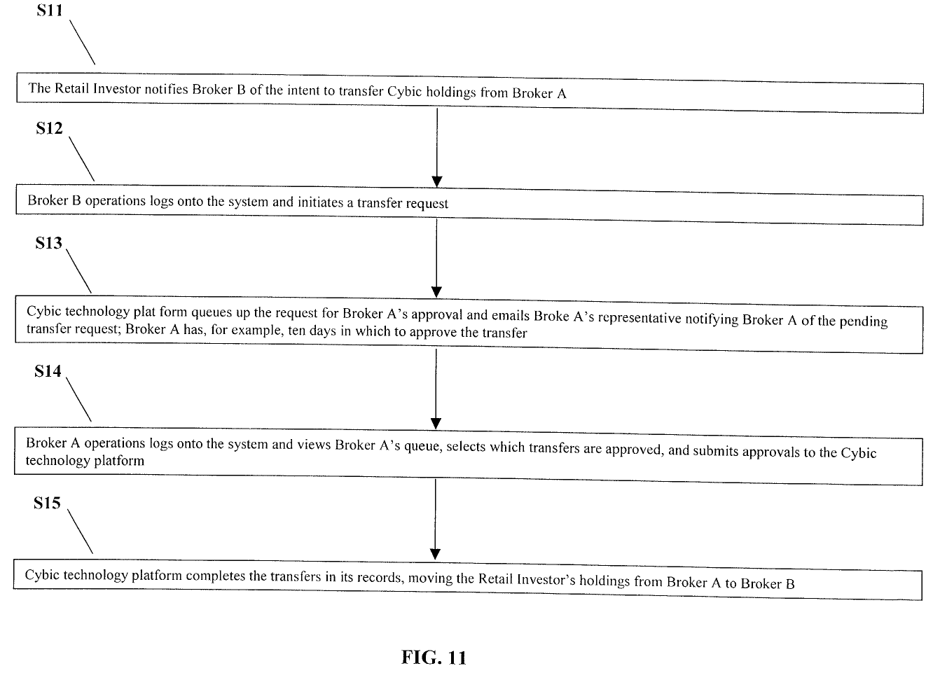

With respect to Account Transfer Management 126, whenever a Retail Investor 10 submits a request to transfer the Retail Investor's Cybic holdings from one account to another, operations can log in and manage the transfer. Two types of transfers include, for example, account transfers within the same Retail Distributor 12 and transfers between two Retail Distributors 12. With the first type, the Retail Investor 10 must have already opened the transfer to account. FIG. 11 is a flow chart which illustrates an example of the process of inter-broker transfer by a Retail Investor 10 from Broker A to Broker B (i.e., between two Retail Distributors 12). Referring to FIG. 11, at S11, the Retail Investor 10 notifies Broker B of the intent to transfer Cybic holdings from Broker A. At S12, Broker B operations logs onto the system 30 and initiates a transfer request. At S13, the Cybic technology platform 30 queues up the request for Broker A's approval and emails Broker A's representative notifying Broker A of the pending transfer request. Broker A has 10 days in which to approve the transfer. At S14, Broker A operations logs onto the system 30 and views Broker A's queue, selects which transfers are approved, and submits approvals to the Cybic technology platform 30. At S15, the Cybic technology platform 30 completes the transfers in its records, moving the Retail Investor's holdings from Broker A to Broker B. Both Retail Distributors 12 (Broker A and Broker B) must be members of the Exchange 14. Transfers to non-members is not supported.

For the Cybic Retail Customer Interface 48, the Cybic technology platform 30 provides a common HTML template and platform for offering Cybic products through the Retail Distributor's web sites. The Cybic technology platform 30 hosts the portion of the site that handles all Cybic products related transactions and information and can mimic the Retail Distributor's look and feel and branding. Once a Retail Investor 10 clicks onto a Cybic hyperlink on the Retail Distributor's web site, the Retail Investor 10 is transferred to the Cybic technology platform 30 site transparently. After being transferred, the Retail Investor 10 can transact. Each successfully executed transaction is messaged back to the Retail Distributor 12 via a dedicated FIX link. Retail Investors 10 can then check their portfolios for end-of-day valuations, or they may select individual positions to get a real-time early redemption quote.

Aspects of the Cybic Retail Customer Interface 48 include, for example, Cybic Product Information 128, Application Submission 130, Product Education Analytics 132, Product Term Selection 134, Price Inquiry 136, Order Entry 138, Portfolio Monitoring 140, and Traditional Broker Support 142. For Cybic Product Information 128, the Cybic Retail Customer Interface 48 provides real-time product offerings. Since it is possible that during the course of the day a product can be suspended or activated, this function provides a real-time list of what products are currently available and what are not. Potential Retail Investors 10 are able to see end-of-day volumes and prices from the previous trading day for each product and class in an easy to read format. It also includes prior day end-of-day volatility information, listed by products, classes, maturity dates and Product Market Makers 16, to provide pricing transparency.

With respect to Application Submission 130, Retail Investors 10 must apply for each Cybic product they wish to use. If a Retail Investor 10 is applying for the first time, the Retail Investor 10 must first take the Cybic scorecard. The scorecard consists of various “Know Your Customer” types of questions, such as “What is your income range?” or “What is your total net worth?” After answering the scorecard questions, the Retail Investor 10 must then read the Cybic disclosure document and agree to the terms stated therein. After completing the scorecard, the Retail Investor 10 must also answer a brief quiz on the product for which the Retail Investor 10 is applying. Upon successful completion of the quiz, agreeing to the terms of the disclosure document and if the Retail Investor 10 has a high enough score, the Retail Investor 10 is given immediate temporary approval for trading in that product. The application is then forwarded to the Retail Distributor's approval queue to await approval by the ROP. If the Retail Investor 10 is not approved by the end of the day, the account is suspended.

Regarding product Education and Analytics 132, the Cybic Retail Customer Interface 48 provides educational materials on Cybic products, which include explanations on the mechanisms of the contracts and the terms of the payoff formulas. As part of the product analytics, “what-if” scenarios are introduced to help Retail Investors 10 understand the risks and returns involved with various Cybic products. Retail Investors 10 are able to see how they might have fared had they purchased a particular Cybic contract in the past by utilizing historical prices of the reference security. Frequently asked questions are also posted with the answers on a FAQ page.

With regard to Product Terms Selection 134, the Cybic Retail Customer Interface 48 provides for each Cybic product a list of Cybic product terms available for purchasing in real time. Dependent upon the structure of the product, the offering list is provided in multiple steps. The first step, for example, is the list of products. Once a Retail Investor 10 chooses a product from the list, the Retail Investor 10 can ask for the classes of that product. This process continues until the product structure does not allow further branching. Then the Retail Investor 10 can choose to buy one or more contracts. Regarding price Inquiry 136, for purchases, Retail Investors 10 may experiment with the many different product configurations using as many indicative quotes as they would like. Once a Retail Investors 10 is ready to purchase a Cybic contract, the Retail Investor 10 next requests a “Buy” quote and begins the Order Entry process 138. However, only Retail Investors 10 who have been approved to purchase that product and who have active accounts may go on to this step. Similarly, for early redemptions, a Retail Investor 10 may choose a particular contract within their portfolio to get an early redemption quote. Again, the Retail Investor 10 can get as many indicative quotes as desired. Once the Retail Investor 10 is serious about selling, the Retail Investor 10 selects “Sell” and gets an official guaranteed sell quote with a time limit.

Retail Investors 10 who wish to place an order on the Exchange 14 must either be approved to use the product in which they are interested or they must own a contract of that product in the case of early redemption. In the case of a purchase, the Retail Investor 10 first selects the product configuration he or she wishes to buy and submits a “request for quote”. This “firm quote” contains a time limit within which the price the Retail Investor 10 sees is guaranteed. The clock starts ticking as soon as the quote leaves the Cybic technology platform 30. The Retail Investor 10 has a certain amount of time within which he or she must respond in order to get the quote the Retail Investors 10 sees. If the Cybic technology platform 30 receives the order after the time limit, it is rejected. Preferably, the limit is set, for example, at thirty seconds. However, this may be adjusted.

Once the Retail Investor 10 receives the firm quote, the Retail Investor 10 chooses how many investment units he or she wishes to purchase and then submits the order to the Exchange 14. The Cybic technology platform 30, in the meantime, requests from the Retail Distributor 12 the Retail Investor's account limit. Once the order is received from the Retail Investor 10, the Cybic technology platform 30 compares the account limit against the Retail Investor's current trade limit to come up with the allowable trade limit. The allowable trade limit is the maximum amount of money the Retail Investor 10 may spend to purchase Cybic contracts. If the order exceeds this limit, it is rejected.

For Retail Investors 10 who have a very slow Internet connection, a “slow server” order type is offered instead of the firm quote. This gives the Retail Investor 10 the option of submitting a “fill-or-kill” order. The fill-or-kill limit is product specific and side specific. For example, for CybicBulls and CybicBears, the limit is placed on the Return Cap on the purchase side only. On the early redemption side, the limit is placed on the dollar price of the contract. In the case of an early redemption, the Retail Investor 10 is first shown the Retail Investor's portfolio holdings. The same order types are supported. The difference between redemption and purchase is that the account limit is not checked. However, the system will confirm that the Retail Investor 10 is not attempting to early redeem more than he or she owns. No short selling of Cybic products is allowed. Once an order is submitted to the Exchange 14, the Retail Investor 10 can check the order status page for the current status of the Retail Investor's order. The order status page displays all orders submitted during that trade date along with the status, whether filled or rejected.

With regard to portfolio Monitoring 140, the Cybic Retail Customer Interface 48 allows the Retail Investor 10 to see his or her portfolio of Cybic holdings. It shows only Cybic products, and any integrated portfolio views must be handled by the Retail Distributor 12. The portfolio displays the last business day's closing valuation, which is the early redemption price. It is important to note that the early redemption price includes early redemption fees. If the contract is held to maturity the value will be slightly higher. From the portfolio view, the Retail Investor 10 may then request a real-time quote. An embodiment of the present invention also supports Traditional Broker Support 142, i.e., non-Internet based brokers. They are provided with a secure site where they may enter customer orders and maintain their customer accounts. All other functions from the embedded customer interface are also supported.

Aspects of the Retail Distributor Back/Middle Office 50 include, for example, Customer position Record Keeping 144, Customer Cash Management 146, Financial Control 148, and Customer Statements 150. The Retail Distributor 12 must be FIX-enabled to receive execution reports. The Exchange 14 provides immediate notification of filled Retail Investor orders, and a nightly file containing all Retail Investor positions. Real-time updates for individual Retail Investor positions are directly available from the Exchange 14 via the Cybic Retail Customer Interface 48. After a trade has been successfully executed on the Exchange 14, a message is sent back to the Retail Distributor's back office system via the dedicated FIX connection notifying them of the trade. Only successfully filled orders are messaged back. The back office system then shadow-books the trade. The product specifics are bidden from the system so that Cybic product transactions look like generic stock transactions. Exercise information by Retail Investor for matured contracts is communicated to the Retail Distributor 12 each evening in the nightly file export.

Before each trade, the Cybic technology platform 30 queries the Retail Distributor's middle office for the Retail Investor's current account limit. The account limit is preferably the current cash on hand, but it could be any other suitable number. The response is utilized by the Cybic technology platform 30, along with the Retail Investor's current trade limit, to determine the Retail Investor's allowable trade limit. The Retail Distributor 12 decides when actual cash is moved into or out of the individual Retail Investor's account to settle orders placed that day. Every night, a file is sent to the Retail Distributor's financial control system detailing each open position by Retail Investor account with the current mark-to-market valuation, any unrealized gain or loss, and realized gains and losses for contracts that were early redeemed or expired that day. The Retail Distributor's normal batch process takes this file and books the financial entries to their accounting records.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the scope of the present invention.

What is claimed is:

1. A method for investing in at least one customizable investment product, comprising:
receiving a selection of at least one customizable investment product for an investor;
receiving a selection of terms for the customizable investment product for the investor;
furnishing the investor a best price quote for the customizable investment product according to the selected terms calculated on the basis of input from a plurality of competing product market makers; and
upon receipt of an acceptance for the investor of the best price quote, executing a trade for the investor based on the acceptance.

2. The method of claim 1, wherein receiving the selection of the customizable investment product further comprises receiving the selection by an exchange platform.

3. The method of claim 1, wherein receiving the selection of the customizable investment product further comprises displaying a list of customizable investment product selections for the investor.

4. The method of claim 3, wherein displaying the list of customizable investment product selections further comprises displaying the list by an exchange platform via a retail customer interface.

5. The method of claim 3, wherein displaying the list of customizable investment product selections further comprises displaying the list which includes at least one of an individual equity related contract with downside protection, a leveraged individual equity contract with limited downside, an equity index contract with an index payout plus a contracted premium, and a collar protection contract for use with an existing equity position with downside protection.

6. The method of claim 1, wherein receiving the selection of the customizable investment product further comprises receiving the selection by an exchange platform via a retail customer interface.

7. The method of claim 1, wherein receiving the selection of the customizable investment product further comprises receiving the selection of an individual equity related contract with downside protection.

8. The method of claim 1, wherein receiving the selection of the customizable investment product further comprises receiving the selection of a leveraged individual equity contract with limited downside.

9. The method of claim 1, wherein receiving the selection of the customizable investment product further comprises receiving the selection of an equity index contract with an exact index payout plus a contracted premium.

10. The method of claim 1, wherein receiving the selection of the customizable investment product further comprises receiving the selection of a collar protection contract for use with an existing equity position with downside protection.

11. The method of claim 1, wherein receiving the selection of the terms further comprises receiving the selection by an exchange platform via a retail customer interface.

12. The method of claim 1, wherein receiving the selection of the terms further comprises displaying a menu of terms for the customizable investment product selections for the investor.

13. The method of claim 12, wherein displaying the menu of terms further comprises displaying the menu by an exchange platform via a retail customer interface.

14. The method of claim 12, wherein displaying the menu of terms further comprises displaying the list which includes at least one of a maturity and a protection level for an individual equity related contract, a maturity and a leverage factor for a leveraged individual equity contract, an index and a sum to invest for an equity index contract, and a period of time for protection and a protection level for a collar protection contract.

15. The method of claim 1, wherein receiving the selection of terms for the customizable investment product for the investor further comprises receiving a selection of a number of investment units, a maturity, and a protection level for an underlying individual equity related contract.

16. The method of claim 15, wherein receiving the selection of terms for the customizable investment product further comprises furnishing a quote for a maximum potential investor gain on the underlying individual equity related contract for the investor.

17. The method of claim 1, wherein receiving the selection of terms for the customizable investment product for the investor further comprises receiving a selection of number of investment units, a maturity, and a leverage factor for a leveraged individual equity contract.

18. The method of claim 17, wherein receiving the selection of terms for the customizable investment product further comprises furnishing a quote for a maximum potential investor gain on the leveraged individual equity contract for the investor.

19. The method of claim 1, wherein receiving the selection of terms for the customizable investment product for the investor further comprises receiving a selection of an index and a sum to invest for an equity index contract.

20. The method of claim 19, wherein receiving the selection of terms for the customizable investment product further comprises furnishing a quote for a lowest management fee offered by a plurality of product market makers on the equity index contract for the investor.

21. The method of claim 1, wherein receiving the selection of terms for the customizable investment product for the investor further comprises receiving a selection of an existing equity position to protect, a number of shares to protect, a protection level, and a period of time for protection for a collar protection contract.

22. The method of claim 21, wherein receiving the selection of terms for the customizable investment product further comprises furnishing a quote for a maximum potential investor gain on the existing equity position for the investor.

23. The method of claim 1, wherein furnishing the best price quote further comprises furnishing the best price quote by an exchange platform via a retail customer interface.

24. The method of claim 1, wherein furnishing the best price quote further comprises receiving a request for the best price quote for the investor.

25. The method of claim 24, wherein furnishing the best price quote further comprises receiving the request by an exchange platform via a retail customer interface.

26. The method of claim 24, wherein furnishing the best price quote further comprises checking for an approval for the investor to trade in the customizable investment product for which the quote is requested.

27. The method of claim 26, wherein checking for the approval further comprises rejecting the request for quote and notifying the investor of the rejection, if the approval is not found.

28. The method of claim 1, wherein furnishing the best price quote further comprises calculating the best price quote by a pricing engine of an exchange platform.

29. The method of claim 28, wherein calculating the best price quote further comprises calculating the best price quote based at least in part on at least one of a retail distributor fee for the customizable product, a product market maker volatility bid-ask spread for the customizable product, and an exchange transaction fee for the customizable product.

30. The method of claim 1, wherein furnishing the best price quote further comprises furnishing the best price quote for an individual equity related contract which includes a maximum potential investor gain.

31. The method of claim 1, wherein furnishing the best price quote further comprises furnishing the best price quote for a leveraged individual equity contract which includes a maximum potential investor gain.

32. The method of claim 1, wherein furnishing the best price quote further comprises furnishing the best price quote for an equity index contract which includes a lowest available management fee.

33. The method of claim 1, wherein furnishing the best price quote further comprises furnishing the best price quote for a collar protection which includes a maximum potential gain on the existing position.

34. The method of claim 1, wherein furnishing the best price quote further comprises sending the best price quote to the investor by a pricing engine of an exchange platform via a retail customer interface.

35. The method of claim 1, wherein executing the trade further comprises receiving the acceptance of the best price quote for the investor by an exchange platform via a retail customer interface.

36. The method of claim 1, wherein executing the trade further comprises executing the trade for the investor by an exchange platform.

37. The method of claim 36, wherein executing the trade further comprises querying an account limit for the investor by the exchange platform.

38. The method of claim 36, wherein executing the trade further comprises querying a current trading limit for the investor by the exchange platform.

39. The method of claim 36, wherein executing the trade further comprises establishing a contract relative to the trade between an options clearing entity and a retail distributor and an identical and offsetting contract between the options clearing entity and a product market maker.

40. The method of claim 39, wherein executing the trade further comprises guaranteeing all obligations under the contract relative to the trade by the options clearing entity.

41. The method of claim 40, wherein executing the trade further comprises centrally maintaining a record of the executed trade for the options clearing entity, the product market maker, and the retail distributor.

42. The method of claim 1, further comprising holding the best price quote open for acceptance by the investor within a pre-determined time-out period.

43. The method of claim 42, wherein holding the best price quote open for acceptance further comprises executing the trade for the investor based on the acceptance upon receipt of the acceptance for the investor of the best price quote within the predetermined time-out period.

44. The method of claim 1, further comprising confirming the trade to the investor.

45. The method of claim 44, wherein confirming the trade further comprises confirming the trade by an exchange platform via a retail customer interface.

46. A system for investing in at least one customizable investment product, comprising:
means for receiving a selection of at least one customizable investment product for an investor;
means for receiving a selection of terms for the customizable investment product for the investor;
means for furnishing the investor a best price quote for the customizable investment product according to the selected terms calculated on the basis of input from a plurality of competing product market makers;
means for receiving an acceptance for the investor of the best price quote; and
means for executing a trade for the investor based on receipt of the acceptance.

47. The system of claim 46, wherein the means for receiving the selection of the customizable investment product further comprises means for receiving the selection by an exchange platform.

48. The system of claim 46, wherein the means for receiving the selection of the customizable investment product further comprises means for displaying a list of customizable investment product selections for the investor.

49. The system of claim 48, wherein the means for displaying the list of customizable investment product selections further comprises means for displaying the list by an exchange platform via a retail customer interface.

50. The system of claim 48, wherein the means for displaying the list of customizable investment product selections further comprises means for displaying the list which includes at least one of an individual equity related contract with downside protection, a leveraged individual equity contract with limited downside, an equity index contract with an index payout plus a contracted premium, and a collar protection contract for use with an existing equity position with downside protection.

51. The system of claim 46, wherein the means for receiving the selection of the customizable investment product further comprises means for receiving the selection by an exchange platform via a retail customer interface.

52. The system of claim 46, wherein the means for receiving the selection of the customizable investment product further comprises means for receiving the selection of an individual equity related contract with downside protection.

53. The system of claim 46, wherein the means for receiving the selection of the customizable investment product further comprises means for receiving the selection of a leveraged individual equity contract with limited downside.

54. The system of claim 46, wherein the means for receiving the selection of the customizable investment product further comprises means for receiving the selection of an equity index contract with an exact index payout plus a contracted premium.

55. The system of claim 46, wherein the means for receiving the selection of the customizable investment product further comprises means for receiving the selection of a collar protection contract for use with an existing equity position with downside protection.

56. The system of claim 46, wherein the means for receiving the selection of the terms further comprises means for receiving the selection by an exchange platform via a retail customer interface.

57. The system of claim 46, wherein the means for receiving the selection of the terms further comprises means for displaying a menu of terms for the customizable investment product selections for the investor.

58. The system of claim 57, wherein the means for displaying the menu of terms further comprises means for displaying the menu by an exchange platform via a retail customer interface.

59. The system of claim 57, wherein the means for displaying the menu of terms further comprises means for displaying the list which includes at least one of a maturity and a protection level for an individual equity related contract, a maturity and a leverage factor for a leveraged individual equity contract, an index and a sum to invest for an equity index contract, and a period of time for protection and a protection level for a collar protection contract.

60. The system of claim 46, wherein the means for receiving the selection of terms for the customizable investment product for the investor further comprises means for receiving a selection of a number of investment units, a maturity, and a protection level for an underlying individual equity related contract.

61. The system of claim 60, wherein the means for receiving the selection of terms for the customizable investment product further comprises means for furnishing a quote for a maximum potential investor gain on the underlying individual equity related contract for the investor.

62. The system of claim 46, wherein the means for receiving the selection of terms for the customizable investment product for the investor further comprises means for receiving a selection of number of investment units, a maturity, and a leverage factor for a leveraged individual equity contract.

63. The system of claim 62, wherein the means for receiving the selection of terms for the customizable investment product further comprises means for furnishing a quote for a maximum potential investor gain on the leveraged individual equity contract for the investor.

64. The system of claim 46, wherein the means for receiving the selection of terms for the customizable investment product for the investor further comprises means for receiving a selection of an index and a sum to invest for an equity index contract.

65. The system of claim 64, wherein the means for receiving the selection of terms for the customizable investment product further comprises means for furnishing a quote for a lowest management fee offered by a plurality of product market makers on the equity index contract for the investor.

66. The system of claim 46, wherein the means for receiving the selection of terms for the customizable investment product for the investor further comprises means for receiving a selection of an existing equity position to protect, a number of shares to protect, a protection level, and a period of time for protection for a collar protection contract.

67. The system of claim 66, wherein the means for receiving the selection of terms for the customizable investment product further comprises means for furnishing a quote for a maximum potential investor gain on the existing equity position for the investor.

68. The system of claim 46, wherein the means for furnishing the best price quote further comprises means for furnishing the best price quote by an exchange platform via a retail customer interface.

69. The system of claim 46, wherein the means for furnishing the best price quote further comprises means for receiving a request for the best price quote for the investor.

70. The system of claim 69, wherein the means for furnishing the best price quote further comprises means for receiving the request by an exchange platform via a retail customer interface.

71. The system of claim 69, wherein the means for furnishing the best price quote further comprises means for checking for an approval for the investor to trade in the customizable investment product for which the quote is requested.

72. The system of claim 71, wherein the means for checking for the approval further comprises means for rejecting the request for quote and notifying the investor of the rejection, if the approval is not found.

73. The system of claim 46, wherein the means for furnishing the best price quote further comprises means for calculating the best price quote by a pricing engine of an exchange platform.

74. The system of claim 73, wherein the means for calculating the best price quote further comprises means for calculating the best price quote based at least in part on at least one of a retail distributor fee for the customizable product, a product market maker volatility bid-ask spread for the customizable product, and an exchange transaction fee for the customizable product.

75. The system of claim 46, wherein the means for furnishing the best price quote further comprises means for furnishing the best price quote for an individual equity related contract which includes a maximum potential investor gain.

76. The system of claim 46, wherein the means for furnishing the best price quote further comprises means for furnishing the best price quote for a leveraged individual equity contract which includes a maximum potential investor gain.

77. The system of claim 46, wherein the means for furnishing the best price quote further comprises means for furnishing the best price quote for an equity index contract which includes a lowest available management fee.

78. The system of claim 46, wherein the means for furnishing the best price quote further comprises means for furnishing the best price quote for a collar protection which includes a maximum potential gain on the existing position.

79. The system of claim 46, wherein the means for furnishing the best price quote further comprises means for sending the best price quote to the investor by a pricing engine of an exchange platform via a retail customer interface.

80. The system of claim 46, wherein the means for executing the trade further comprises means for receiving the acceptance of the best price quote for the investor by an exchange platform via a retail customer interface.

81. The system of claim 46, wherein the means for executing the trade further comprises means for executing the trade for the investor by an exchange platform.

82. The system of claim 81, wherein the means for executing the trade further comprises means for querying an account limit for the investor by the exchange platform.

83. The system of claim 81, wherein the means for executing the trade further comprises means for querying a current trading limit for the investor by the exchange platform.

84. The system of claim 81, wherein the means for executing the trade further comprises means for establishing a contract relative to the trade between an options clearing entity and a retail distributor and an identical and offsetting contract between the options clearing entity and a product market maker.

85. The system of claim 84, wherein the means for executing the trade further comprises means for guaranteeing all obligations under the contract relative to the trade by the options clearing entity.

86. The system of claim 85, wherein the means for executing the trade further comprises means for centrally maintaining a record of the executed trade for the options clearing entity, the product market maker, and the retail distributor.

87. The system of claim 46, further comprising means for holding the best price quote for acceptance by the investor within a pre-determined time-out period.

88. The system of claim 87, wherein the means for holding the best price quote for acceptance further comprises means for executing the trade for the investor based on the acceptance upon receipt of the acceptance for the investor of the best price quote within the pre-determined time-out period.

89. The system of claim 46, further comprising means for confirming the trade to the investor.

90. The system of claim 89, wherein the means for confirming the trade further comprises means for confirming the trade by an exchange platform via a retail customer interface.

91. A method for investing in at least one customizable investment product, comprising:
receiving a selection of at least one customizable investment product for an investor, selected from a group of customizable investment products consisting of an individual equity related contract with downside protection, a leveraged individual equity contract with limited downside, an equity index contract with an index payout plus a contracted premium, and a collar protection contract for use with an existing equity position with downside protection.
receiving a selection of terms for the customizable investment product for the investor, selected from a group of terms consisting of a maturity and a protection level for the individual equity related contract, a maturity and a leverage factor for the leveraged individual equity contract, an index and a sum to invest for the equity index contract, and a period of time for protection and a protection level for the collar protection contract;
furnishing the investor a best price quote for the customizable investment product according to the selected terms calculated on the basis of input from a plurality of competing product market makers; and
upon receipt of an acceptance for the investor of the best price quote, executing a trade for the investor based on the acceptance.
